(19) United States
(12) Patent Application Publication
(10) Pub. No.: US 2026/0279221 A1
(43) Pub. Date: Sep. 17, 2026

(54) SYSTEM AND METHOD FOR ADAPTIVE MULTI-AGENT TRAINING CONTENT GENERATION VIA ITERATIVE SUBJECT MATTER EXPERT (SME) CAPTURE AND RETRIEVAL-AUGMENTED GENERATION

(71) Applicant: ZYGLIO, INC., Reston, VA (US)

(72) Inventor: Jonathan MERRIL, Reston, VA (US)

(73) Assignee: ZYGLIO, INC., Reston, VA (US)

(21) Appl. No.: 19/077,282

(22) Filed: Mar. 12, 2025

(51) Int. Cl. G09B 9/00; G06F 40/40; G06N 3/042

(52) U.S. Cl. CPC G09B 9/00; G06N 3/042; G06F 40/40

(57) ABSTRACT

Creating and managing user-personalized training content using generative artificial intelligence includes: storing task profiles including a subject identifier identifying a specific task and subject matter expert training materials for the specific task; storing user profiles including a user identifier and one or more raw media input and their derivative representations of the user performing a task tagged with a subject identifier; receiving a request for user-personalized training materials including a user identifier and a subject identifier; identifying a user profile that includes a user identifier included in the request; identifying a task profile that includes a subject identifier included in the request; generating, using a generative AI model, the user-personalized training materials based on one or more differences between the one or more SME materials of the identified task profile and the one or more raw media inputs and their derivative representations of the identified user profile.

### FIELD

The present disclosure relates to systems and methods for creating, managing, and monetizing a generative artificial intelligence (AI) content creation platform designed for the personalized generation of user-specific training materials. The system leverages subject matter expert (SME) training materials, individual user performance data, and real-time AI-driven content adaptation to optimize learning outcomes.

### BACKGROUND

Many industries rely on an apprenticeship model in which a mentor observes a trainee, such as a student, performing a procedure and provides real-time verbal feedback. This feedback may include guidance on the proper use of instruments, interaction with technology interfaces, demonstrations of correct techniques, and identification of errors or suboptimal actions. For centuries, this model has served as the primary method for transferring critical skills from mentor to trainee. However, while effective in many cases, the apprenticeship model has significant limitations.

For example, traditional apprenticeship-based learning lacks scalability, standardization, and the ability to provide consistent, detailed performance analysis across multiple training sessions. Trainees often receive feedback in an ad-hoc manner, with no structured evaluation of their performance metrics and no reliable method for reviewing or replaying their actions to reinforce learning. Modern advancements in simulation-based training offer the potential to enhance the traditional apprenticeship model by providing scalable, repeatable, and adaptive training environments.

However, existing simulation technologies are often static, offering limited or no real-time feedback and failing to provide personalized, dynamic mentorship that adapts to an individual trainee's performance. Furthermore, most traditional systems lack integration with multi-modal instructional content, such as dynamically retrieved images, audio-based instructional elements, interactive text, and real-time annotations obtained through retrieval-augmented generation (RAG). Without these enhancements, current training methods fail to fully adapt to diverse learning styles, optimize knowledge retention, or provide data-driven, personalized feedback that evolves based on trainee performance.

With the emergence of advanced artificial intelligence models, including large language models such as ChatGPT, it is now feasible to generate precise, context-aware responses to user inquiries. However, the contextual background necessary to fully understand and apply such information is not always readily apparent. By employing generative AI techniques (which produce novel content including text, images, audio, video, and music) there exists a significant opportunity to create training and educational materials that not only provide accurate answers but also incorporate foundational and scaffolded information, thereby enhancing the learner's comprehension of key concepts.

Accordingly, a need exists for an innovative technological solution capable of generating personalized content derived from subject matter expert instructional materials and individual user performance data. The present disclosure addresses this need by providing an agile, generative AI-driven system that facilitates live simulations featuring responsive, multi-role interactions and adaptive assessment mechanisms. This system integrates pre-and post-simulation evaluations to effectively measure and enhance cognitive skills and improve knowledge retention over time.

### SUMMARY

The disclosed system and method enables live, multi-agent simulations incorporating real-time adaptive feedback loops, dynamically adjusting scenario complexity, instructional guidance, and user-specific coaching. The platform supports pre-and post-simulation multiple-choice assessments, intelligently tagged by key performance indicators (KPIs), educational objectives, skill proficiency levels, degree of difficulty, and end-user specialization to enhance adaptive learning pathways.

Additionally, the system and method integrates retrieval-augmented generation (RAG) technology to facilitate dynamic content retrieval, instructional augmentation, and contextual enrichment. This includes the real-time selection, modification, and synthesis of multimedia content, such as images, videos, audio, text articles, and their derivative representations, ensuring contextually relevant and continuously evolving training experiences tailored to individual learner needs.

A system and method for creating and managing user-personalized training content using generative artificial intelligence is disclosed. The method comprises storing task profiles in a database, wherein each task profile includes a subject identifier uniquely designating a specific task and one or more subject matter expert (SME) training materials, including text documents, videos, diagrams, and three-dimensional simulations. The method further comprises storing user profiles, each including a unique user identifier and one or more raw media inputs and their derivative representations (e.g., audio recordings, text transcripts, semantic annotations) tagged with a corresponding subject identifier. The method further includes receiving a training request from a user computing device that includes a user identifier and a subject identifier and identifying the corresponding user profile and task profile.

The system and method further involves generating user-personalized training content using a generative AI model that employs a multi-agent orchestration framework. This framework conducts iterative, multi-pass interviews with SMEs using retrieval-augmented generation (RAG) and corrective RAG (CRAG) techniques to capture, structure, and integrate domain-specific knowledge, including detailed decision-tree pathways and procedural workflows, into a structured knowledge base. The generated training content comprises both static educational materials and dynamic simulation training scenarios with real-time adaptive feedback and is tailored based on the differences between the SME training materials and the user's performance data.

The generated training content is then transmitted to the user computing device. This approach enables scalable, adaptive training environments that dynamically adjust instructional content based on real-time user performance, continuous SME input, and integrated decision-making models, thereby enhancing overall training effectiveness and durability.

In one exemplary embodiment, the present disclosure further incorporates a method for constructing comprehensive knowledge representations through structured, multi-pass interviews with subject matter experts. These interviews are facilitated by advanced large language models and are conducted in successive passes. In an initial pass, a high-level description of the procedure or technique is captured. In subsequent passes, the conversation is refocused to identify potential challenges, areas of difficulty, and critical decision points. Additional passes then refine the procedure further by detailing strategies to optimize the outcome. Moreover, these interviews may involve multiple participants or roles (such as the lead surgeon, operating room nurse, anesthesiologist, and device representative) to capture diverse perspectives and ensure that the resulting simulation scenarios are realistic, auditable, and richly detailed.

For instance, the disclosure includes a method for creating and managing user-personalized training content using generative artificial intelligence (AI) comprises:
(a) storing in a database maintained by a processing server one or more task profiles, each task profile comprising a subject identifier that uniquely designates a specific task and one or more subject matter expert (SME) training materials for that task, wherein the SME training materials may be processed in multiple passes to enhance instructional accuracy and consistency;
(b) storing in the database one or more user profiles, each user profile comprising a user identifier and one or more user records that capture raw media inputs and their derivative representations (such as audio, video, motion data, biometric feedback, and text) generated during the user's execution of a task, wherein each record is tagged with a corresponding subject identifier;
(c) receiving, via a receiving device of the processing server from a user computing device, a personalized training request that includes both a user identifier and a subject identifier;
(d) identifying, by a processor of the processing server, the user profile corresponding to the provided user identifier and the task profile corresponding to the provided subject identifier;
(e) generating, by the processor using a generative AI model, user-personalized training materials based on analyzing differences between the SME training materials of the identified task profile and the user records of the identified user profile tagged with the same subject identifier, the generation process including:
   (i) comparing the SME training materials with the corresponding user records to detect discrepancies, skill gaps, or performance deviations;
   (ii) incorporating multi-pass SME validation whereby the SME training materials are iteratively refined and supplemented with additional expert input; and
   (iii) utilizing a multi-agent system to simulate diverse training scenarios and provide responsive, role-based guidance based on the detected differences;
(f) transmitting, by a transmitting device of the processing server, the generated user-personalized training materials to the user computing device; and
(g) further generating adaptive, AI-driven multiple-choice assessments and dynamic simulation scenarios that integrate multimedia instructional materials retrieved via retrieval-augmented generation (RAG) technology, thereby providing real-time instructional augmentation, comprehensive performance analysis, and continuous feedback through live, multi-agent interactions.

This method ensures that personalized training content is dynamically adapted based on both expert-provided material and real-time user performance data, enhancing the learning experience through iterative expert refinement and interactive, multi-role simulation.

As another instance, the disclosure includes a system for creating and managing user-personalized training content using generative artificial intelligence (AI) that includes:
a processor; and
a non-transitory memory coupled to the processor and storing instructions that, when executed by the processor:
   cause the system to perform operations to: store, in a database, one or more task profiles, each of the one or more task profiles including a subject identifier identifying a specific task and one or more subject matter expert (SME) training materials for the specific task;
   store, in the database, one or more user profiles, each of the one or more user profiles including a user identifier and one or more user records of the user performing a task, wherein each of the one or more modalities of audiovisual input or their derivative processed representations is tagged with a subject identifier;
   receive, from a user computing device, a request for one or more user-personalized training materials, the request including a user identifier and a subject identifier;
   identify a user profile of the one or more user profiles that includes a user identifier matching the user identifier included in the request; identify a task profile of the one or more task profiles that includes a subject identifier matching the subject identifier included in the request; and
   generate, using a generative AI model, the one or more user-personalized training materials based on one or more differences between the one or more SME training materials of the identified task profile and the one or more user records of the identified user profile having a subject identifier matching the subject identifier included in the request,
wherein generating the one or more user-personalized training materials includes:
   comparing the one or more SME training materials of the identified task profile and the one or more user records of the identified user profile having a subject identifier matching the subject identifier included in the request;
   identifying one or more differences between the one or more SME training materials of the identified task profile and the one or more user records of the identified user profile having a subject identifier matching the subject identifier included in the request; and
   transmitting the one or more user-personalized training materials to the user computing device.

In various exemplary embodiments, the system integrates advanced machine learning techniques, retrieval-augmented generation (RAG), and multi-agent orchestration to continuously update the compiled dataset with real-time performance feedback, thereby ensuring that the mentor-based AI system remains current and adaptive by prompting for additional SME input as needed to address identified content gaps and evolving industry standards.

Furthermore, the system employs an expert-driven, multi-pass Socratic inquiry process that (i) surfaces best practices; (ii) breaks down procedures into critical steps and nuanced decision points; (iii) identifies potential failure points, optionally categorized by frequency (e.g., common at 10%, occasional at 5%, and rare at 1%); (iv) incorporates comprehensive, 360-degree perspectives from various operating room roles; and (v) refines simulation scenarios to improve long-term outcomes. As a result, the system creates a robust training framework for future use by practitioners such as surgeons and other doctors, as well as a wide birth of other professions. In embodiments, SME data is entered via structured interviews, conducted with Large-Language-Model (LLM)-facilitated, multi-pass sessions for instance, that capture workflows, decision points, and multi-role perspectives, thereby producing realistic and auditable simulation models.

In one embodiment, the system further abstracts a comprehensive knowledge workflow from structured interviews with subject matter experts (SMEs). In these interviews, an advanced LLM agent, optionally configured with specialized prompts, conducts a multi-pass dialogue that captures not only the sequential procedural steps but also critical decision points, alternative strategies, and fallback measures inherent in expert practice. The system then encodes the resulting data into a structured format (e.g., YAML, which is a human-readable data serialization language that is often used for writing configuration files) to produce a detailed knowledge map that represents the entire workflow. Simultaneously, the system extracts key decision junctures and converts them into decision tree structures that are loaded into corresponding agentic LLM personas. These personas, operating with retrieval-augmented generation (RAG) techniques, are further equipped with document-generation modules, such as those provided by WeasyPrint©, ReportLab©, or wkhtmltopdf©, to automatically generate accurate, auditable standard operating procedures (SOPs) and educational review documents. Thus, the system supports both the generation of static educational materials and dynamic, interactive simulations that adapt in real time to a learner's performance, ensuring that training content remains closely aligned with expert best practices and is continuously updated based on evolving industry standards.

In one embodiment, the system deploys an LLM-based agent configured with a detailed prompt that incorporates structured data from SME interviews, optionally including workflows, decision points, and fallback strategies, to generate comprehensive instructional content. This agent is integrated with PDF generation plug-ins, such as WeasyPrint©, ReportLab©, or wkhtmltopdf©, which automatically convert the generated output into well-formatted Standard Operating Procedures (SOPs) and educational review documents. By cross-referencing the captured decision trees and expert insights with real-time data, the agent ensures that the resulting documents are accurate, auditable, and conform to industry standards. This approach not only facilitates the production of static educational materials but also supports the dynamic generation of interactive content, thereby enhancing both the reliability and the instructional value of the training framework.

### BRIEF DESCRIPTION OF THE DRAWING FIGURES

The scope of the present disclosure is best understood from the following detailed description of non-limiting exemplary embodiments when read in conjunction with the accompanying drawings. Included in the drawings are the following figures:

FIG. 1 is a block diagram illustrating a high-level system architecture for creating and managing user-personalized training content using generative artificial intelligence in accordance with certain exemplary embodiments.

FIG. 2 is a block diagram illustrating the processing server of the system of FIG. 1 for creating and managing user-personalized training content using generative artificial intelligence (AI) in accordance with exemplary embodiments.

FIGS. 3A and 3B are flow diagrams illustrating a process for generating and managing user-personalized training content using generative artificial intelligence (AI) within the system of FIG. 1, in accordance with certain exemplary embodiments.

FIG. 4 is a flow chart illustrating an exemplary method for generating and managing user-personalized training content using generative artificial intelligence (AI) in accordance with exemplary embodiments.

FIG. 5 is a flow chart illustrating an exemplary method for generating diversified educational materials and documentation for training in accordance with exemplary embodiments.

FIG. 6 is a flow chart illustrating an exemplary method for dynamically adapting a simulation training environment based on multi-modal ingestion of user performance data in accordance with exemplary embodiments.

FIG. 7 is a flow chart illustrating an exemplary method for gamifying user training performance using blockchain technology in accordance with exemplary embodiments.

FIG. 8 is a computer architecture chart illustrating exemplary embodiments.

FIG. 9 is a block diagram illustrating a computer system architecture in accordance with exemplary embodiments.

FIG. 10A-10E is pseudocode in accordance with exemplary embodiments.

Further areas of applicability of the present disclosure will become apparent from the detailed description provided hereinafter. It should be understood that the detailed description of exemplary embodiments is intended for illustration purposes only and are, therefore, not intended to necessarily limit the scope of the disclosure or any invention claimed herein.

### DETAILED DESCRIPTION

### System and Method for Creating and Managing User-Personalized Training Content

The present disclosure provides a novel technical solution for creating, managing, and monetizing a generative artificial intelligence content creation platform. Particularly, exemplary embodiments of the methods, systems, and computer program products provided for herein enable the generation of user-personalized training materials based on subject matter expert training material and individual user performance using generative artificial intelligence. Current computer-based content generation technologies are often static and lack the ability to provide real-time feedback and personalized mentorship that adjusts dynamically to student performance. Further, most existing content generation methods and systems are limited in their ability to capture multi-modal data (e.g., video, instrument movement, or human sentiment indicators) and provide integrated feedback across these modalities.

Exemplary embodiments of the methods, systems, and computer program products disclosed herein provide an innovative AI-powered mentor-based simulation system that integrates subject matter expert (SME) materials with advanced, AI-driven instructional models while continuously recording and analyzing student interactions and performance. These embodiments leverage diverse datasets, including data from multiple sources and simulation scenarios, to create enriched educational experiences. In one aspect, the system compiles SME materials and associated contextual information to form a comprehensive dataset that is used to train and fine-tune an AI model, such as a large language model (LLM), to establish a robust mentor-based AI framework. Furthermore, the methods, systems, and computer program products disclosed herein incorporate mechanisms for identifying data gaps and dynamically querying SMEs, thereby constructing a comprehensive model of subject matter expertise that underpins the adaptive, mentor-based simulation system.

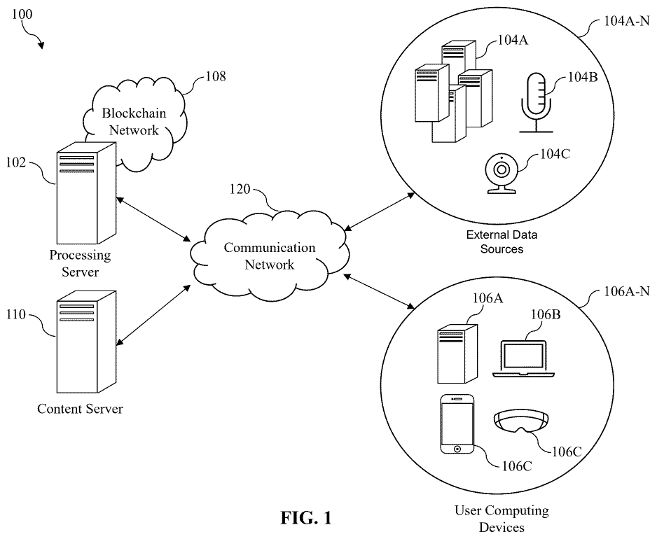

FIG. 1 illustrates a system 100 for generating and managing user-personalized training content using generative artificial intelligence (AI). In one embodiment, the architecture further incorporates a live simulation engine designed to support multi-agent interactions, adaptive multiple-choice assessment modules, and instructional content augmentation through retrieval-augmented generation (RAG) technology. The system 100 provides a modular framework that enables learners to receive training content curated based on a comparison of their performance with subject matter expert (SME) instructional materials. In various embodiments, the system integrates adaptive learning algorithms, real-time analytics, and multi-modal data fusion to continuously update and tailor training content in response to evolving user performance metrics and external authoritative sources. Moreover, the system supports live simulation experiences featuring multi-agent interactions and adaptive, real-time feedback to adjust training pathways based on both pre-simulation and post-simulation evaluation metrics.

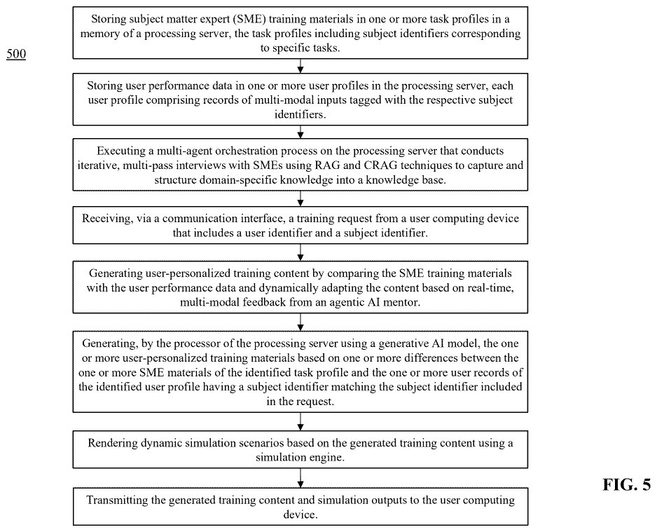

As illustrated in FIG. 1, the system 100 may include a processing server 102, which can be implemented using a server, cloud server, desktop computer, notebook, laptop computer, tablet, handheld device, smartphone, thin client, smartwatch in combination or alone, or any other electronic computing system, capable of storing, compiling, and organizing audio, visual, and/or textual data and communicating with external data sources 104 (e.g., 104A-104N), user (or users) computing devices (e.g., 106A-106N), and content servers (e.g., 110) via a network (e.g., 120) to carry out one or more various functions disclosed herein. The processing server 102 is configured to orchestrate adaptive content creation using generative AI models that integrate real-time data, dynamic multimedia assets, and multiple-choice assessments to drive personalized learning outcomes. For instance, as illustrated in FIG. 5, the processing server 102 may receive SME materials from external data sources 104A-104N and user data from user (or users) computing devices 106A-106N and then generate one or more user-personalized training materials using one or more machine learning algorithms. These training materials can be rendered in any suitable data type, including text, audio, video, and interactive media alone or in combinations.

The SME materials may encompass LLM-driven interactive conversations with SMEs to capture raw media, analyses of procedural decisions, and potential decision outcomes, as well as trainer media in formats that may be exclusively audio and/or text, alongside textbooks, diagrams, articles, presentations, slide decks, speeches, white papers, technical papers, manuals, PDFs, Word® documents, podcasts, films, and other relevant formats, depending on the industry. Although a single processing server 102 is depicted, it is understood that multiple processing servers may be employed, and the functions performed by the processing server 102 may alternatively be executed on user computing devices 106A-106N. In certain embodiments, the system's functionality is further enhanced through the integration of multi-agent orchestration and real-time voice interaction capabilities, thereby delivering a more interactive and context-sensitive training experience.

The overall system architecture supports cloud-based processing, scalable data storage, and the integration of vector and knowledge graph technologies, in addition to real-time multi-modal interactions required for adaptive training content generation. Furthermore, the architecture incorporates a specialized SME capture module that facilitates structured, multi-pass interviews with SMEs. This module employs advanced LLM agents equipped with detailed prompts to capture comprehensive workflows, decision points, and fallback strategies, which are subsequently encoded into structured representations (e.g., in YAML format). The extracted decision trees are then integrated into an agentic framework that informs both dynamic simulation scenarios and the generation of static educational materials. For example, an LLM agent, interfaced with PDF generation plug-ins (such as WeasyPrint©, ReportLab©, or wkhtmltopdf©), may automatically produce accurate Standard Operating Procedures (SOPs) and educational review documents that are auditable and compliant with current industry standards. This comprehensive integration ensures that the system continuously refines its training content based on real-time performance feedback and evolving SME input, thereby enhancing instructional value and overall training effectiveness.

In the system 100, the processing server 102 may receive SME materials from one or more external data sources 104A-104N. In embodiments, the system employs retrieval-augmented generation (RAG) to retrieve not only traditional SME materials but also supplementary multimedia content, including images, videos, and text articles, that are dynamically annotated for instructional augmentation. The external data sources 104A-104N may encompass any device, system, or entity that produces, stores, or otherwise makes available SME materials for a given industry. Such sources may include, without limitation, cameras, microphones, optical sensors, radio-frequency devices, ultrasound devices, patterned gloves with fiduciary markers, ultrasonic trackers, external computer systems 104A (e.g., servers, cloud servers, desktop computers, notebooks, laptops, tablets, handheld devices, smartphones, thin clients, smartwatches, or any other electronic computing system capable of storing, compiling, and organizing audio, visual, and/or textual data and facilitating bidirectional communication with the processing server 102), user computing devices 106A-106N, and content servers (e.g., 110) over a network (e.g., 120). For example, as illustrated in FIG. 5, external data sources may include computing systems as well as academic institutions, research institutions, cataloguing services, book publishers, colleges and universities, laboratories, standard-setting entities, and regulatory agencies, in addition to providing illustrative segments, commentary, or fully formed SME materials, whether crowd-sourced or supplied by professors, professionals, or subject matter experts, that comprise text, audio, and/or video content. Moreover, external data sources may include cameras (e.g., camera 104C) and microphones (e.g., microphone 104B) deployed during SME training sessions. In certain embodiments, these sources capture raw media inputs from SMEs and trainees engaged in various tasks across multiple technical fields, along with derivative data such as text transcripts, tokenized sequences, embedded vectors, semantic annotations, phonetic transcriptions, time-stamped metadata, and other representations. For instance, in a medical procedure setting, a camera (e.g., 104C) and a microphone (e.g., 104B) may be located in an operating room to capture video and audio of SMEs and/or trainees performing a surgical procedure, and external data sources 104A-104N may further include device tracking sensors attached to surgical instruments used by the SME and/or trainee. Additionally, these external data sources can record audio narrations of critical features and key educational points identified by the SME during data capture sessions or in separate structured or unstructured interviews using audio devices, such as a mobile device or microphone 104B, and subsequently transmit the captured audio to the processing server 102. In advanced embodiments, the collected multi-modal data is integrated into a unified knowledge base, enabling the system to generate enhanced, contextually aware training materials through advanced analytics and real-time data fusion.

In addition, the one or more external data sources 104A-104N may include external server systems hosting AI models, such as, but not limited to, ChatGPT. For example, the processing server 102 may access ChatGPT's voice application programming interface (“API”), known as the “Realtime API,” which provides access to the “Advanced Voice Mode” feature. This feature enables the integration of natural, real-time voice interactions with AI models, thereby supporting live, interactive, voice-based simulations with immediate feedback. Such interactions allow users, via the user computing device 106, to engage in direct voice-to-voice exchanges and receive contextually accurate verbal responses within the user-personalized training materials.

Furthermore, the system 100 is designed to integrate additional text-to-voice and voice-to-text solutions, such as Whisper©, Sesame.ai©, ElevenLabs©, and other similar technologies, to enhance the naturalness and responsiveness of its voice-based interactions. The flexible architecture of system 100 also permits the incorporation of video and graphical elements alongside spoken dialogue, thereby providing realistic visual feedback, scenario visualizations, and role-play components.

For example, in a medical simulation training scenario, the processing server 102 may generate personalized training materials in which medical trainees interact with AI-driven virtual patients and instructors. These materials can incorporate anatomical images, diagnostic aids, and video content to simulate complex procedures while delivering natural verbal feedback and guidance. Similarly, in crisis and law enforcement training, the system may enable first responders and law enforcement personnel to practice crisis scenarios involving real-time verbal communication with virtual civilians and situational visuals, thereby enhancing decision-making and situational awareness.

In corporate communication skills training, the processing server 102 can generate training materials where customer service, sales, and leadership trainees engage in simulated scenarios with AI-driven virtual customers or colleagues, integrating graphics and video to provide situational context along with real-time voice interaction for practicing critical communication skills. In language learning applications, the processing server 102 may produce training materials that facilitate interactive dialogues, supported by visual aids, pronunciation guides, and contextual media, with multiple language options available for user selection. This comprehensive approach enhances language comprehension through the combined use of auditory and visual feedback.

The system 100 can also include one or more user computing devices 106A-106N. In embodiments, the one or more user computing devices 106A-106N support multi-modal interactions, including real-time voice, touch, and gesture controls, and incorporate adaptive dashboards and interactive feedback modules to further enhance the user experience. These devices are configured to support high-fidelity, multi-modal interactions, enabling users to access personalized training simulations, dynamic assessments, and adaptive content reviews seamlessly. The user computing devices 106A-106N can be a device utilized by a user to interact with the processing server 102, the external data sources 104A-104N, and/or the content server 110 for accessing services provided thereby. The user computing devices 106A-106N can communicate with the processing server 102, the external data sources 104A-104N, and/or the content server 110 via the communication network 120 and can utilize a webpage, application program, application programming interface (API), or other suitable method for communicating with the processing server 102, the external data sources 104A-104N, and/or the content server 110. A user interface displayed by the user computing devices 106A-106N to the user can enable the user to request user-personalized SME training materials from the processing server 102.

The system 100 can also include an content server 110. Additionally, the system supports dynamic integration of contextually relevant contents and sponsored content within the personalized training materials, ensuring a monetizable, secure training ecosystem. The content server 110 may be a server, a cloud server, a desktop computer, a notebook, a laptop computer, a tablet computer, a handheld device, a smart-phone, a thin client, a smartwatch, or any other electronic device or computing system capable of storing, compiling, and organizing audio, visual, or textual data and receiving and sending that data to and from other computing devices, such as the processing server 102, the external data sources 104A-104N, and/or the user computing devices 106A-106N via the communication network 120. The external data sources 104A-104N can include the same types of devices as the content server 110, and the user computing devices 104A-104N but with emphasis on such devices and virtual/augmented reality (VR) displays, motion sensors (including tactile and image capture), microphones, facial expression devices, eye movement and gaze detectors, wearable cameras, and any other suitable device that can detect or capture the movement, attention, and emotional/sentiment or state of the user). The content server 110 can generate, store, manage, and transmit contents for insertion into the user-personalized SME materials generated by the processing server 102 and viewed by the user computing devices 106A-106N. The contents can include, but are not limited to, banner ads, video ads, and/or sponsored content segments. In embodiments, the content server 110 can function as part of the same entity as the processing server 102 and/or the content server 110 can function independently of the processing server 102. For example, the content server 110 can function as an content database for the processing server 102 for contents generated and/or received by the processing server 102. Alternatively, and/or together with an internal content database, the content server 110 can be operated by a third-party content entity that provides contents to the processing server 102. In embodiments, the processing server 102 generates user-personalized training materials for a specific topic and the processing server 102 then requests relevant contents for insertion and/or display with the user-personalized training materials. In embodiments, the content server 110 is integrated with real-time analytics to dynamically tailor ad placement based on user performance and content context, ensuring that contents complement and enhance the training experience.

In embodiments, the network 120 is the Internet, representing a worldwide collection of networks and gateways to support communications between devices connected to the Internet. The network 120 may be secured via robust encryption, access control, and compliance with industry standards to ensure that all transmitted data, including sensitive training and performance metrics, is protected. The network 120 may include, for example, wired, wireless or fiber optic connections. In other embodiments, the network 120 may be implemented as an intranet, a local area network (LAN), or a wide area network (WAN). In general, the network 120 can be any combination of connections and protocols that will support communications between the processing server 102, the external data sources 104A-104N, the user computing devices 106A-106N, and the content server 110. In embodiments, the network 120 may distributed network such as a peer-to-peer (P2P) network. In embodiments, the network 120 may also incorporate hybrid cloud architectures and edge computing to minimize latency and support real-time, interactive training simulations.

In an exemplary embodiment, a user, via a user computing device, e.g., the user computing device 106A, can electronically transmit a request for user-personalized training materials to the processing server 102 via the communication network 120 using any suitable communication method. The request for user-personalized training materials can include a user identifier identifying the user and a subject identifier identifying a specific task for which the user wants the user-personalized training materials for. For example, the user may be a surgical resident requesting user-personalized training materials for performing a specific surgical procedure. The processing server 102 can utilize the user identifier included in the request to identify a user profile 212 for the user of the user computing device 106A (e.g., the user profile 212 stored in a profile database 210 of the processing server 102). The user identifier can be, for example, a username, a user account number, an e-mail address, a telephone number, an employee identification number, a student identification number, a professional registration number, or any other user identification capable of personally identifying an individual user, which can also use two-factor authentication. This authentication process is integrated into the system's access control and authorization mechanisms to ensure that only properly verified users can access sensitive training content and simulation modules.

The processing server 102 utilizes the subject identifier included in the request to identify a corresponding task profile for the specific task denoted by the subject identifier (e.g., a task profile 208 stored in a database 206). The subject identifier may be implemented as a predefined subject code generated by the processing server 102, a subject matter keyword, or any other unique identifier capable of designating an individual task. For example, if a user seeks personalized training materials for a surgical procedure such as a kidney transplant, the subject identifier may be “kidney transplant” or an alphanumeric code assigned by the processing server 102. In certain embodiments, the processing server 102 further utilizes the subject identifier to identify an associated mentor profile (e.g., a mentor profile 211 stored in the profile database 210) corresponding to the specific task. Additionally, adaptive analytics may be applied to refine the request by incorporating historical user performance data and contextual information, thereby enhancing the personalization of the generated training materials. The request may also include parameters for additional simulations, enabling the system 100 to automatically generate case variations with minimal SME input, thus facilitating agile content creation.

The user profiles 212 stored in the database 210 of the processing server 102 can include the user identifier as discussed in more detail above and user data. The user data can include raw media inputs and their derivative representations (such as text transcripts, tokenized sequences, embedded vectors, semantic annotations, phonetic transcriptions, time-stamped metadata) such as raw media inputs and their derivative representations (such as text transcripts, tokenized sequences, embedded vectors, semantic annotations, phonetic transcriptions, time-stamped metadata) of the user performing specific tasks, audio, of the user performing specific tasks, user-generated materials (e.g., documents, diagrams, models, specifications, etc.), or any other materials related to the specific task being performed by the user. The user data can also include previously generated user-personalized training materials generated by the processing server 102. User data may also encompass performance on adaptive, multiple-choice pre-and post-simulation assessments, which are used to dynamically refine the training content and measure cognitive skill improvements over time. In embodiments, the user data can be uploaded to the processing server 102 by one or more users on the user computing devices 106A-106N. For example, a user interface may be provided on the user computing devices 106A-106N to enable a user to upload the user data to the processing server 102. The user interface can include a drag-and-drop function to enable users to upload user date stored on the one or more user computing devices 106A-106N.

Further, the user interface can include a progress bar to indicate the status of the user date upload. The database 210 can include patient profiles 213 associated with one or more real-life and/or fictional patients for use by the processing server 102 in generating the user-personalized training materials. The patient profile 213 can include a patient identifier and patient data that enables the processing server 102 to generate user-personalized training materials for a specific task being performed on that patient. For example, the patient data can include a patient's medical history, physical attributes (e.g., sex, age, height, weight, etc.), medical images (e.g., CAT scans, MRIs, PET scans, x-rays, etc.). In certain embodiments, the user requests user-personalized training materials for performing a surgical procedure on a particular patient and the processing server 102 can include a patient identifier and the processing server 102 can identify a patient profile 213 in addition to the user profile 212 and the task profile 208 to generate user-personalized training materials for performing the surgical procedure on the identified patient. In certain embodiments, the user profiles 212 are further enriched with real-time performance analytics and multi-modal sensor data, while patient profiles are integrated with external health databases and imaging repositories to support high-fidelity, patient-specific simulations.

The task profiles 208 stored in the database 206 include a subject identifier that uniquely designates a specific task, along with one or more subject matter expert (SME) training materials associated with that task. These SME materials are obtained by the processing server 102 from one or more external data sources 104A-104N. As described herein, the SME materials may comprise content generated from LLM-directed interviews with SMEs, including raw media inputs and their derivative representations (such as text transcripts, tokenized sequences, embedded vectors, semantic annotations, phonetic transcriptions, and time-stamped metadata), as well as trainer media provided in audio and/or text format, and supplementary instructional content including textbooks, diagrams, books, articles, presentations, slide decks, speeches, white papers, technical papers, manuals, PDFs, Word® documents, podcasts, films, and other relevant formats, depending on the industry. In certain embodiments, SME materials may be uploaded directly to the processing server 102 by users via one or more user computing devices 106A-106N using a user interface that supports drag-and-drop functionality and displays a progress bar indicating upload status.

In certain embodiments where a task profile 208 already exists, the processing server 102 inputs newly received or retrieved SME materials into one or more machine learning algorithms to identify any content gaps. Upon detecting such gaps, the system automatically generates queries or requests for supplemental SME input to address deficiencies, ensuring comprehensive documentation of critical elements such as anatomy, risks, alternative actions, and procedural steps. Moreover, the processing server 102 leverages advanced deep learning techniques and retrieval-augmented generation (RAG) to automatically detect content gaps and dynamically request additional SME input, thereby maintaining task profiles that are both comprehensive and current.

Once the SME materials are received, the processing server 102 generates a summary of key points extracted from these materials, which can be displayed to users via one or more user computing devices 106A-106N. In addition, the processing server 102 employs an ontology-based approach to extract key concepts and define relationships among them, for example, identifying prerequisite relationships, and to generate metadata such as difficulty level, estimated learning time, and learning objectives for each concept. Using this information, the processing server 102 can construct learning paths for each task profile 208, where concepts are represented as nodes and their interrelationships as edges, thereby determining optimal learning trajectories based on learner goals and current knowledge states. The curriculum ontology for each task profile 208 may represent items of study, their interrelationships, and associated learning materials (e.g., video clips).

Furthermore, the processing server 102 may define specific educational scenarios in which agent technology facilitates structured dialogue with the learner, enabling scenario-based role-play and assessment. The system can also provide competency mapping features that visualize the learner's progress toward achieving requisite skills and knowledge. In embodiments, the ontology-based planning system automatically synthesizes curricula based on defined learning objectives and the available resources.

The mentor profiles 211 stored in the profile database 210 of the processing server 102 can each store a trained generative AI persona associated with one or more of the task profiles 208. The trained generative AI persona can be a virtual avatar of a SME for a specific task of an associated task profile 208. For example, in a medical training scenario, the processing server 102 may generate or utilize a trained generative AI persona of a doctor, a nurse, and/or a surgical technician, etc. The processing server 102 can generate the mentor profiles 211 in advance of any requests from user, e.g., the user computing devices 106. For example, the processing server 102 can generate pre-trained AI personas based on the data retrieved from the external data sources 104A-N. The pre-trained AI personas ls can be generated by the processing server 102 using one or more machine learning algorithms and/or neural networks. Types of machine learning algorithms and/or neural networks the processing server 102 may utilize include, but are not limited to, image classification models, large language models (LLMs), natural language processing models, deep learning algorithms, artificial neural networks, generative artificial networks, convolutional neural networks (CNN), recurrent neural networks (RNN), generative adversarial neural networks (GANN), feedforward neural networks (FNN), or any other suitable machine learning algorithms and/or neural networks capable of generating the pre-trained AI personas.

In embodiments, such pre-trained AI personas can be updated and used in further generating user-personalized training materials once a user request for training materials is received, as discussed in more detail below. For example, the processing server 102 can update the pre-trained AI personas of the one or more mentor profiles 211 using retrieval-augmented generation (RAG) techniques such as by incorporating one or more user records into the pre-trained AI personas. For example, the processing server 102 may leverage large language models (LLMs) to ingest a comprehensive corpus of domain-specific knowledge (e.g., relevant to a specific task of the task profiles 208), enabling the pre-trained AI persona to function as a proficient mentor across various scenarios. The processing server 102 can actively solicit and incorporate additional materials from the external data sources 104, including updates from SMEs, to maintain and expand its knowledge base. The processing server 102 can solicit such additional materials on a continuous or periodic basis.

Once the processing server 102 had identified the user profile 212 and the task profile 208 in response to the received request from the user, e.g., the user computing device 106A, the processing server 102 generates the requested user-personalized training materials based on one or more differences between the one or more SME materials of the identified task profile 208 and the one or more user records of the identified user profile 212 having a subject identifier matching the subject identifier included in the request. The processing server 102 can generate the requested user-personalized training materials by comparing the one or more SME materials of the identified task profile 208 and the one or more user records of the identified user profile 212 having a subject identifier matching the subject identifier included in the request and identifying one or more differences between the one or more SME materials of the identified task profile 208 and the one or more user records of the identified user profile 212. The user-personalized training materials can be generated by the processing server 102 using one or more machine learning algorithms and/or neural networks.

Types of machine learning algorithms and/or neural networks the processing server 102 may utilize include, but are not limited to, image classification models, large language models (LLMs), natural language processing models, deep learning algorithms, artificial neural networks, generative artificial networks, convolutional neural networks (CNN), recurrent neural networks (RNN), generative adversarial neural networks (GANN), feedforward neural networks (FNN), or any other suitable machine learning algorithms and/or neural networks capable of generating the user-personalized training material. For example, the processing server 102 may leverage large language models (LLMs) to automatically generate user-personalized training materials, in a user-desired language, to best accommodate the user's specific challenges or needed areas of improvement, e.g., in comparison to the SME materials. These user-personalized training materials can be created in real-time, discussed in more detail below, offering immediate audio and or visual guidance, or produced on-demand after the session for further study. The ability of LLMs to adapt and generate user-personalized training materials allows for flexible learning experiences and supports ongoing student development. The machine learning algorithm and/or neural network can be trained by the processing server 102 to generate user-personalized training materials using datasets that include SME materials stored in the task profiles 208 in the database 206 and the user data of the user profiles 212 stored in the profile database 210.

This generation process may further incorporate adaptive, AI-driven multiple-choice assessments and scenario-based simulations with responsive feedback, ensuring that both pre-training and post-training evaluations are seamlessly integrated to enhance learning outcomes. Once a machine learning algorithm and/or neural network is trained to generate user-personalized training materials, new user data, e.g., a new user video, can be input into the trained machine learning algorithm and/or neural network, which can output a user-personalized training material for a user, e.g., the user computing device 106A. The processing server 102 can include advanced video customization and editing capabilities designed to capture and structure user-personalized training materials based on the SME materials or real-time trainee interactions during simulations. The system 100 can automatically record and edit video footage or still images of surgical procedures or trainee performance, allowing for the creation of linear instructional media that can be used for both real-time learning and post-simulation review.

Furthermore, the system can incorporate fully simulated anatomic and procedural simulations using software such as Unity® that enables the creation of three-dimensional, real-time audiovisual simulations. In one embodiment, the Unity-based simulation engine is seamlessly integrated with the multi-agent system to dynamically cue simulation scenarios based on structured SME input and real-time performance data. Specifically, the multi-agent system, which captures comprehensive workflows, decision points, and alternative strategies from subject matter expert interviews, is configured to generate adaptive cues in the form of decision trees and performance metrics. These cues are transmitted to the Unity engine, which then modulates the simulation environment to reflect contextually appropriate scenarios, such as adjustments in anatomical detail, procedural complexity, or potential complication events. This integration enables not only the generation of static educational materials, such as standard operating procedures, but also the real-time, interactive simulation of surgical and procedural environments, ensuring that trainees receive immersive, adaptive, and responsive instruction aligned with expert best practices.

In one embodiment, the multi-agent system communicates simulation cues to Unity using network-based protocols that enable low-latency, real-time data transfer. For example, the system can employ a RESTful® Application Program Interface (API) to initiate communication and WebSockets© to maintain a persistent connection between the multi-agent system and the Unity simulation engine. In this configuration, the multi-agent system formats simulation cues, such as decision tree outputs, performance metrics, and scenario triggers, in a JavaScript Object Notation (JSON) structure that is transmitted over the WebSocket© connection. Unity, using custom C# scripts and networking libraries (for instance, Unity's built-in WebSocket support or third-party frameworks like Mirror© or MQTT/ZeroMQ© implementations), receives these JSON messages and dynamically adjusts simulation parameters accordingly. This approach ensures that real-time cues derived from structured SME interviews and performance data are efficiently parsed and integrated into the Unity environment, enabling adaptive, interactive, and contextually appropriate simulation scenarios for educational purposes.

The user-personalized training materials can include annotations, visual aids, audio and text-based feedback to highlight key learning points or areas requiring improvement. Further, instructors and SMEs have the ability to further customize the digital media by cutting, re-arranging, or annotating segments, tailoring the content to specific educational goals or student needs. The user-personalized training materials can be integrated directly into the real-time simulation environment, where they are dynamically played to provide guidance during the procedure. In embodiments, these training materials are integrated directly into the real-time simulation environment, where they are dynamically played to provide immediate, context-sensitive guidance during the procedure. In embodiments, these profiles are further augmented by dynamically retrieved RAG content, such as multimedia references and instructional articles, that are annotated for significance by AI, with SME review.

In certain embodiments, the generation of user-personalized training materials further incorporates one or more AI personas derived from mentor profiles 211. For example, the processing server 102 identifies one or more mentor profiles 211 associated with the identified task profile 208 and generates the requested training materials based on differences between the SME materials within task profile 208 and the user records contained in user profile 212, where all records are associated with the same subject identifier, as well as by integrating the identified mentor profiles 211. In these embodiments, the resulting training materials include one or more dynamically generated AI personas, which may be presented simultaneously in a training video and, when multiple AI personas are included, may interact with one another to simulate realistic multi-agent scenarios. For instance, in a medical training scenario, the personalized training video may feature an operating room nurse AI persona and a radiology technician AI persona engaging in coordinated simulation.

Further, embodiments permit the user request to specify a role designation, whereby the processing server 102 generates training materials tailored to the designated role within the specific task defined in task profile 208. The processing server 102 may enhance voice-based simulations using customer experience (CX) and interactive voice response (IVR) technologies, such as those implemented in Google Dialogflow CX© and other IVR systems that leverage large language models, by employing state-based conversation flows, context management, intent detection, entity recognition, adaptive prompting and feedback, multi-turn dialogues, voice-specific features, sentiment and confidence analysis, event and error handling, real-time data integration, and training analytics. This comprehensive utilization of CX and IVR concepts enables the generation of training materials that are dynamic, realistic, and engaging, while providing valuable instructional feedback.

In additional embodiments, the task profiles 208 may include one or more pre-tests designed to assess a user's current proficiency and specific educational needs. The processing server 102 can identify and administer these pre-tests via the user computing device 106, and then utilize the test results to further refine the generation of user-personalized training materials. For example, the results may highlight discrepancies between the SME materials of task profile 208 and the performance data contained in user profile 212, thereby guiding the agentic system to adjust its interactive dialogue, modifying the level of guidance, depth of questioning, and feedback, in accordance with the learner's demonstrated knowledge and experience.

In certain embodiments, a user operating a user computing device 106 may submit a request for generic training materials that excludes the use of personal performance data. In such cases, the request may include only a subject identifier. The processing server 102 then generates the requested training materials by referencing the SME materials associated with the task profile 208 corresponding to the provided subject identifier and, optionally, by integrating one or more mentor profiles 211 as described herein.

In alternative embodiments, where the training materials are personalized based on existing user data, the generated content may include personalized feedback in the form of audio, video, or still images. This personalized feedback may incorporate real-time performance footage, for example, video data stored in the user profile 212, and annotations generated by the processing server 102. Additionally, the system may capture and analyze real-time audio conversations from the user during simulations. Advanced speech-to-text (as well as text-to-speech) and natural language processing algorithms convert the captured audio into actionable insights, which are then used to dynamically adapt both the simulation environment and the agentic interactions. This process tailors the feedback and instructional content to the learner's verbal inputs and overall engagement, thereby enhancing the personalization and effectiveness of the training experience.

In exemplary embodiments, the system 100 provides user-personalized feedback media, comprising, but not limited to, audio, text, and interactive content, that deliver detailed information regarding a user's performance, including identified strengths and areas for improvement. The processing server 102 customizes such feedback media based on the individual's performance data, wherein a large language model (LLM) analyzes user responses to challenges, procedural actions, and interactions with previously generated user-personalized training materials. For instance, the system may generate a summary of a user's performance, such as accuracy in executing a specific task, thereby tailoring the training experience to each user's unique learning profile to enhance knowledge retention and skill mastery.

In further embodiments, the personalized feedback media may be provided in audio and/or text form and can be supplemented with one or more assessments administered at various intervals, including pre-simulation, post-simulation, and at spaced intervals (e.g., weekly) to evaluate learning gaps and the durability of learning outcomes. Additionally, the feedback media may incorporate interactive elements, such as clickable annotations and integrated simulation controls, to further support the user's acquisition and review of specific skills or procedures, either in part or in their entirety.

The system 100 is designed to support various simulation modalities, including low-fidelity simulations, high-fidelity simulations, and patient-specific simulations. In low-fidelity simulations, the user-personalized training materials may comprise sketch-based diagrams, audio cues or conversational prompts, or simple two-dimensional simulations that facilitate navigation of a specific task. Such low-fidelity simulations may depict the anatomical landscape, outline procedural steps, identify potential hazards, and describe contingency plans, and may be accessible via portable devices (e.g., smartphones equipped with styluses) and integrated voice-based interactions with an AI mentor. Conversely, in high-fidelity simulations, the training materials may present realistic three-dimensional or 2.5-dimensional interactive graphics of a surgical field, which users can navigate and pause to allow AI mentors, instructors, or trainees to annotate directly on the display, thereby recognizing features, indicating procedural plans, or providing real-time corrective input.

In patient-specific simulations, the processing server 102 replicates real-world cases to enable trainees to rehearse procedures in anticipation of actual surgeries, with users able to employ dynamic sketches and annotations within an actual surgical environment for enhanced intraoperative assistance. Moreover, the simulations may incorporate characters, dialogues, and interactive elements that mirror real-world conditions, allowing users to make decisions that directly influence simulation outcomes, thereby reinforcing the training objectives.

Additionally, the user-personalized training materials may include narrative-based simulations that feature personalized video and audio content, complete with dialogues and characters, depicting scenarios likely to be encountered during the performance of the specific task. These narrative-based simulations may incorporate decision points that require user input, where, for example, the user is presented with two or more response options, with the selected option dictating the subsequent flow of the simulation. In certain embodiments, such narrative-based simulations further incorporate real-time adaptive decision-making models that dynamically adjust the simulation based on user inputs and performance, ensuring a highly personalized and engaging training experience.

In embodiments, the user-personalized training material can be provided by the processing server 102 to the user, e.g., the user computing device 106A in real-time. For example, the user, e.g., the user computing device 106A user, e.g., the user computing device 106A, can transmit the request for user-personalized training material when the user is about to begin the specific task, and the processing server 102 can generate and transmit the user-personalized training material as a live-stream to the user computing device 106A. This live streaming capability is enhanced by real-time memory and data exchange, enabling the simulation to adjust dynamically based on continuous analysis of user performance and sensor input. In embodiments, the live-streamed training material incorporates adaptive real-time analytics and sensor fusion to provide immediate corrective feedback and enriched visualizations and/or audio feedback, further enhancing the training experience. Continuing with the surgical example, the user, e.g., the user computing device 106A, can transmit the request for user-personalized training material just before the user is about to perform a simulated medical procedure, e.g., a kidney transplant. The processing server 102 can generate and transmit the user-personalized training material to the user, e.g., via the user computing device 106A. In embodiments, the user computing device 106A, can include a display interface, such as a display screen, a projector, VR viewer, etc., for displaying the generated user-personalized training material. For example, if the user-personalized training material is a high-fidelity 3-dimensional simulation, the user computing device 106A may be or may be in communication with virtual reality glasses, e.g., user computing device 106C, worn by the user (using real-time software such as UNITY© as described herein). In embodiments, the user can use a combination of user computing devices 106A-106N. For example, the personalized training material may include video and audio components and the processing server 102 may transmit a combination or sole use of video, audio or text component to a display screen, e.g., the user computing device 106B, and the audio component to a microphone. Further, in embodiments where the user-personalized training material is transmitted in real time, the processing server can receive user data, e.g., video, audio and/or text, from the user, e.g., the user computing device 106A, on a continuous basis and dynamically update the user-personalized training material based on a continuous analysis of the received user data using the machine learning algorithms and/or neural networks, as discussed above. For example, in a surgical environment, if the processing server 102 determines that the user has made an error in handling a surgical implement, the processing server 102 can dynamically update the user-personalized training material with an annotation indicating the error. Further, the processing server 102 can utilize patient data stored in one or more patient profiles 213 to dynamically update physiological responses by the patient in the user-personalized training material in response to the user's detected movements. For example, if the user moves a scalpel in the wrong direction that would result in a cut on the patient, the processing server 102 can update the user-personalized training material to illustrate the cut and the resulting blood flow. Furthermore, in such a situation, the processing server 102 can update the user-personalized training material to guide the user in correcting the error.

In certain embodiments, the user-personalized training material is delivered by the processing server (102) to a user computing device (106A) via a versatile user interface. This interface may be implemented as a graphical user interface (GUI), an application programming interface (API), a website, an audio conversational interface, or any other suitable means for presenting the training material. The interface may include a goal input element, such as a dropdown menu or text field, and an accompanying calendar that is displayed when a user initially interacts with the platform or following major milestones, allowing the user to specify educational goals (e.g., “master advanced cardiac life support”) and set target dates.

Additionally, the interface may present a competency map for each task that a user has initiated or completed. This competency map can be rendered as a graphical depiction (e.g., a competency wheel or bar) on the main dashboard, and may provide interactive elements such as hover or click details that display lists of required skills and current progress, color-coded completion rings indicating progress levels, inline progress bars tracking learning goals, and action buttons (e.g., “view competency details”) for in-depth progress reports. The interface may further display personalized insights and statistics, such as module completion rates, time spent on tasks, and quiz performance metrics (including score trends and average time per question), derived from both real-time and review simulation data.

Moreover, the user interface may incorporate focus suggestions (e.g., pop-up or chat prompts), topic flags that highlight areas of below-average performance, and actionable items providing one-click access to recommended articles, practice questions, or coaching sessions. A competency heatmap, presented as a color-coded matrix, may visually depict proficiency levels, while mouseover tooltips may reveal numerical values or concise explanations regarding specific skill levels. Users may also access a detailed view with recommended improvement tasks via “click-to-dive-deeper” functionality.

In further embodiments, the user interface includes a library tab that displays uploaded SME materials, user data, and external resources. A suggestion element may also be provided, listing static or dynamic media, such as audio, text, or diagrams, that have been uploaded to augment educational content. For instance, a presenter may input a key phrase associated with a video, after which the processing server 102 “splices” the corresponding media into a class or curriculum.

During playback of the user-personalized training materials, the interface may offer options for tracking progress, such as an interactive live radar chart or spider diagram that visually represents a user's current competency levels relative to target benchmarks. Additionally, the interface may incorporate interactive challenges that periodically emerge, triggered by specific sponsors, achievements, or other factors, with game-like features including countdown timers and point scoring systems. A peer comparison display may also be provided to present anonymized performance comparisons with other users who have completed training for the same task. Furthermore, a “learning style” toggle may allow users to switch between text-heavy visual presentations and interactive modes. Alternatively, the interface may be provided, in whole or in part, as a conversational audio interface.

In certain embodiments, the user-personalized training material generated by the processing server 102 may be employed in a hybrid training environment that integrates AI-generated content with human mentorship. For example, a mentor using a user computing device (e.g., 106D) may submit a request for user-personalized training material intended for a specific trainee (e.g., device 106A), with the request including a mentor identifier. The processing server 102 then verifies the mentor identifier by querying the profile database 210 to confirm its inclusion within the trainee's user profile (212). Upon successful verification, the processing server 102 generates and transmits the user-personalized training material to the mentor device (e.g., 106D), enabling the mentor to utilize this content in conjunction with their own instructional guidance.

In additional embodiments, the system 100 supports multi-modal collaboration between mentors and trainees by facilitating real-time joint review sessions and interactive feedback. The system may also compile collaborative interactions and relevant materials into comprehensive briefings that incorporate instructional augmentation, including images, multimedia content (audio and/or text), videos, and annotated text retrieved via retrieval-augmented generation (RAG), to enhance learner comprehension. Alternatively, agentic SME personas, which are trained using specific explanations and materials provided by designated SMEs, may be selected as “approved SMEs” to serve as virtual mentors within the training process.

In an embodiment, there can be a mixture of human and agentic SME's. There is also an embodiment for the ability to select an amalgamation of specific human and agentic SMEs. These virtual and agentic SME's can be deployed simultaneously and/or sequentially in an educational experience using this system.

The system 100 can function within the context of an organization's CRM/HR system (customer relationship management/human resource) product such as PeopleSoft®, SalesForce®, and HubSpot®, etc. Integrating the system 100 with platforms like SalesForce® and HubSpot® requires a strategic approach to ensure seamless data exchange and functionality. The following integrations are essential. For example, for SalesForce®, the system 100 may integrate one or more application programming interfaces (APIs) such as REST© API and/or SOAP© API. REST API performs operations such as creating, reading, updating, and deleting records. REST API supports JSON and XML formats, facilitating efficient data manipulation. SOAP API offers robust capabilities, especially useful for server-to-server integrations. As another example, for HubSpot®, the system 100 may integrate one or more HubSpot® application programming interfaces (APIs) to access and manage contact, company, and deal records, enabling synchronization of customer data, use the Forms© API to capture and submit data from custom forms into HubSpot©, facilitating lead generation and tracking. These integration standards ensure that the system's interoperability is maintained and that data flows seamlessly across multiple enterprise platforms. The system 100 can implement OAuth 2.0 for secure authorization, allowing the system to access user data without exposing credentials. Both Salesforce® and HubSpot® support OAuth 2.0, ensuring secure and standardized authentication. Additionally, the integration of OAuth 2.0 within the system's multi-tenant architecture facilitates robust security protocols. The system 100 can establish data mapping protocols to align the system's data structures with those of Salesforce® and HubSpot® to ensure accurate data exchange and consistency across platforms. This process leverages advanced data transformation techniques, ensuring that data consistency and integrity are maintained throughout the integration process. The system 100 can utilize the Salesforce Platform Events© to receive real-time notifications about changes in data, enabling the system to respond promptly to updates and/or the system 100 can utilize webhooks to receive notifications about specific events, such as contact creation or form submissions, allowing the system to process and respond to these events in real-time. These event-driven mechanisms ensure immediate data synchronization and adaptive response capabilities, supporting dynamic learning environments. The system 100 can use middleware solutions or integration platforms to facilitate communication between the system 100 and CRM platforms. These tools can handle data transformation, error handling, and process automation, streamlining the integration process. Middleware solutions not only manage data translation and error logging but also support process automation for seamless integration. By implementing these integrations, the system can effectively interface with Salesforce®, HubSpot®, and similar platforms, enhancing its capabilities in customer engagement and data management. This seamless interfacing enables real time data exchange and improved operational efficiency across platforms.

The system 100 can function within the context of an organization's Learning Management Systems (LMS). The system 100 can utilize Sharable Content Object Reference Model© (SCORM), which is a set of technical standards for e-learning software products. It governs how online learning content and Learning Management Systems communicate and work together. SCORM enables the packaging of content into a transferable format and tracks learner progress and performance across different platforms. The system 100 can utilize xAPI, which is a standard that allows tracking of learning experiences, both online and offline. xAPI captures a wide range of learner activities and stores them in a Learning Record Store (LRS), providing detailed insights into learning behaviors. LTI (Learning Tools Interoperability®) is a standard developed by the IMS Global Learning Consortium to integrate learning applications with platforms like LMSs. LTI enables seamless integration of external tools and content into an LMS, allowing for a unified learning experience. The system 100 can utilize Customer Relationship Management (CRM) Integration Standards such as 1) RESTful APIs (Representational State Transfer), which are a set of guidelines for building scalable web services and allow for interaction with CRM systems over HTTP, 2) SOAP® (Simple Object Access Protocol), which is a protocol for exchanging structured information in web services and facilitates communication between applications over a network, often used in enterprise-level CRM integrations, and/or 3) OAuth (Open Authorization), which is an open standard for access delegation that allows third-party services to exchange information without exposing user credentials, ensuring secure data transmission between systems.

By implementing these standards, the system 100 is capable of interfacing effectively with Learning Management Systems (LMS) and Customer Relationship Management (CRM) systems. This integration facilitates the recording, recognition, and management of educational activities through uni- or bi-directional data transmission, ensuring that both educational content and learner interactions are accurately tracked and managed across platforms, thereby enhancing the overall learning experience. Furthermore, these standards enable adaptive learning and KPI-driven personalization. The system's capability to dynamically generate and integrate adaptive pre-and post-simulation assessments, along with multimedia instructional overlays, confers a significant competitive advantage in corporate training environments by continuously tailoring and updating training materials to meet evolving learner needs.

Alternatively, the system 100 may be deployed as a direct-to-consumer application that enables individuals to independently manage their interactions with the platform. In this configuration, users can employ the system for self-directed training, pre-employment screening, and skill development applicable to a wide range of potential employment opportunities across various companies. In certain embodiments, integration with CRM and HR systems is enhanced through AI-driven analytics that track user progress and optimize training interventions. This seamless integration, achieved by adhering to established standards, ensures efficient data exchange and interoperability between system 100 and an organization's CRM/HR platforms, thereby enhancing overall functionality.

The system is designed to accommodate a diverse array of professional training scenarios, notably in customer engagement. It offers an optional rewards mechanism to enhance motivation and participant engagement. The system supports multi-role training in parallel scenarios, involving multiple human participants and/or AI-driven role-based simulations. This flexibility allows for versatile training experiences and presents economic opportunities by broadening the range of training offerings. The underlying architecture ensures that these training experiences are scalable, interactive, and highly engaging.

In customer engagement training, the system can simulate various customer interactions, enabling trainees to develop skills in communication, problem-solving, and relationship management. The optional rewards feature can be configured to provide incentives, such as points or badges, based on performance metrics, thereby fostering a competitive and engaging learning environment. Real time data analytics and adaptive feedback loops power these simulations, ensuring that each interaction is both meaningful and measurable.

The multi-role training capability allows participants to assume different roles within a scenario, facilitating a comprehensive understanding of various perspectives and responsibilities. The system can operate with multiple human participants or substitute certain roles with AI-driven simulations, ensuring consistent and scalable training experiences. This adaptability not only enhances the versatility of the training programs but also reduces the need for extensive human resources, leading to cost-effective solutions for delivering a wide range of training scenarios. Advanced role-based access controls and dynamic simulation frameworks support this flexible, multi-role training approach.

By integrating these features, the system provides a robust platform for professional development, particularly in areas requiring nuanced interpersonal skills and adaptive learning environments. The combination of customizable rewards and flexible role assignments ensures that training programs can be tailored to meet specific organizational needs, thereby maximizing both engagement and learning outcomes. Cutting edge AI technologies and multi-agent simulations, underpin this robust platform for professional growth.

The invention is broadly applicable across a variety of industries, including healthcare, hospitality, retail, financial services, and manufacturing. In healthcare, for example, the system supports live, interactive simulations of surgical and medical procedures with adaptive, multi-modal feedback and assessments that enable personalized training and improved patient outcomes. In other industries, the system's adaptive, AI-driven content generation and assessment capabilities address specific training needs to enhance workforce performance. Its inherent adaptability is particularly advantageous for sectors characterized by high-stakes roles, high turnover, and a continual need for upskilling.

By delivering tailored training solutions, the invention effectively addresses the unique challenges of each industry. For instance, in healthcare, system 100 can reduce turnover and facilitate continuous skill enhancement for nurses, medical technicians, and emergency responders, ensuring practitioners remain current with medical advancements. In hospitality, the system supports the development of exceptional customer service skills for front desk staff, concierge services, and customer relations managers, addressing elevated turnover rates. In retail, it aids in cultivating consultative selling skills and customer service excellence for sales associates, customer service representatives, and store managers. In financial services, system 100 addresses regulatory compliance challenges, complex product offerings, and the maintenance of client trust for bank tellers, financial advisors, and customer support agents. In manufacturing, it helps close skill gaps arising from technological advancements and enforces safety compliance for machine operators, quality control inspectors, and maintenance technicians.

Leveraging the system enables organizations in these industries to effectively meet their training needs, resulting in improved employee performance, reduced turnover, and enhanced service quality. These industry-specific training solutions are further supported by real-time performance tracking and adaptive feedback mechanisms, ultimately fostering a more resilient and efficient workforce underpinned by advanced AI and data analytics.

The system 100 is designed to operate seamlessly within an organization's learning management system (LMS), customer relationship management (CRM) system, and broader corporate security infrastructure. The system securely integrates with enterprise platforms such as Workday, Salesforce, and HubSpot via standardized application programming interfaces (APIs) (e.g., REST, SOAP) and robust authentication protocols (e.g., OAuth 2.0), ensuring that all user data, training content, and performance metrics are transmitted securely and in compliance with enterprise security standards. Moreover, the system employs a multi-tenant architecture to isolate data, thereby protecting corporate information and ensuring seamless interoperability with existing HR and CRM systems.

In one embodiment, the system 100 (e.g., processing server 102) stores developmental benchmarks, such as within user profile 212, that are continually compared against real-time user performance data. This dynamic comparison enables the system to adjust learning materials and behavior modification techniques in real time. The benchmarks incorporate performance metrics from adaptive assessments, ensuring that the training content evolves based on both immediate user performance and longitudinal trends in cognitive skill development. For example, the processing server 102 may include an initial screening and behavioral assessment module (e.g., as part of analysis module 220), a customized developmental pathways and behavioral intervention engine (e.g., as part of generation module 218), a feedback and progress monitoring mechanism (e.g., as part of feedback module 222), and a long-term skill development and behavioral reinforcement module (e.g., also as part of feedback module 222). In certain embodiments, these benchmarks are continuously refined using reinforcement learning techniques, ensuring that the training materials dynamically adapt to individual learning trajectories and performance improvements.

In exemplary embodiments, the processing server 102 employs both parallel and sequential data retrieval processes to acquire knowledge-based content items and supplemental instructional materials. Such materials include RAG-sourced images, media in audio and/or text formats, text articles, and derivative representations (e.g., text transcripts, tokenized sequences, embedding vectors, semantic annotations, phonetic transcriptions, and time-stamped metadata) used for instructional augmentation during simulations and in post-simulation review. For example, once the processing server 102 identifies discrepancies between the SME training materials in task profile 208 and the user records in user profile 212, it may execute parallel retrieval by simultaneously querying multiple external data sources, or sequential retrieval by performing iterative queries that progressively refine initial content to fill knowledge gaps and correct inaccuracies.

The system 100 further leverages AI's capacity to ingest and actively solicit additional content, effectively remediating identified knowledge gaps essential for mentoring. By integrating AI-driven assessments with human-centric mentorship, the system establishes a dynamic roadmap for mentees'career development. In certain embodiments, this process is further augmented by automated query generation and real-time feedback from external SME sources. Additionally, the system incorporates dynamic multiple-choice question generation, in which questions are auto-tagged by the AI according to key performance indicators, learning objectives, and difficulty levels, subject to SME review, to continuously calibrate and enhance the training content. The retrieval process is further enhanced by leveraging distributed computing architectures and real-time data aggregation, ensuring that the content repository is continuously updated to maintain current and accurate training materials.

In certain embodiments, the processing server 102 is configured to ingest supplemental SME materials and other content not initially used in generating the user-personalized training materials by employing retrieval-augmented generation (RAG) and/or corrective RAG (CRAG). In this process, the system retrieves, annotates, and integrates multimedia instructional assets, including audio, text, images, videos, and text-based articles, to augment the simulation environment with real-time, contextually relevant information that may be further annotated by SMEs for enhanced instructional significance. RAG synthesizes additional SME materials and related assets to ensure comprehensive coverage of the relevant industry or specific task, while CRAG employs an iterative corrective mechanism that verifies and refines the generated training materials through secondary retrievals to improve accuracy and reliability. This dual mechanism ensures that the AI mentor's knowledge base remains both expansive and precise. Consequently, the disclosed methods and systems enable AI models to actively ingest and solicit additional content, thereby effectively remediating knowledge gaps critical for mentoring. By integrating AI-driven assessments with human-centric mentorship, the system establishes a robust roadmap for mentee career development, as evidenced by recent programs. This approach not only identifies areas requiring further information but also actively acquires and incorporates such content, thereby enhancing overall mentoring effectiveness.

In exemplary embodiments, the system 100 employs a dual-phase AI mentor ingestion and processing framework to significantly enhance its mentoring capabilities. This framework integrates both static domain knowledge and dynamic, real-time data, ensuring that the AI mentor remains current with the latest advancements in the field while adapting to the educational level and technical proficiency of the user. The first phase, termed General Knowledge Acquisition, encompasses both an initial ingestion step and subsequent continuous learning processes. During the initial ingestion step, the AI mentor assimilates a comprehensive corpus of domain-specific knowledge, thereby enabling it to function as a proficient mentor across a variety of scenarios. In certain embodiments, this ingestion process leverages natural language processing and deep learning techniques to extract, index, and organize critical information for efficient retrieval and application in mentoring contexts.

In one embodiment, the system further abstracts a comprehensive knowledge workflow from structured interviews with subject matter experts (SMEs). In these interviews, an advanced large language model (LLM) facilitates a multi-pass dialogue to capture not only the sequential procedural steps but also critical decision points and alternative pathways inherent in the expert's methodology. The captured information is encoded into a structured format, such as YAML, to produce a knowledge map that represents the entire workflow. Concurrently, the system extracts key decision junctures during the SME interview and converts these into decision tree structures that are loaded into respective agentic LLM personas. Literature describing advances or review articles in the field can be entered as RAG information into the system and provide the LLMs that are interviewing the SMEs with context to device questions or the SME and further refine the captured procedural knowledge used in the system. These LLM personas then serve dual functions: (i) they enable the generation of static educational materials, such as standard operating procedures (SOPs) and technical manuals; and (ii) they support the creation of interactive, real-time simulation environments and adaptive assessment modules by dynamically generating contextual questions and scenarios. By integrating these structured workflows and decision trees with retrieval-augmented generation (RAG) techniques, the system ensures that both static and dynamic instructional outputs remain current, auditable, and closely aligned with expert best practices, thereby substantially enhancing the training and performance evaluation of learners.

In embodiments, the system 100 employs a bifurcated approach comprising a continuous learning phase and a Personalized Educational Adaptation phase to ensure that the AI mentor remains both broadly knowledgeable and highly responsive to individual learner needs. In the continuous learning phase, the processing server 102 actively solicits and incorporates additional materials, including updates from SMEs and dynamically retrieved external multimedia content via retrieval-augmented generation (RAG), to continuously expand and refine its knowledge base for instructional augmentation.

In the Personalized Educational Adaptation phase, the system 100 executes a series of steps including pre-assessment analysis, adaptive content selection, real-time adjustment, and post-evaluation interactions. During the pre-assessment analysis, the AI mentor administers tailored pre-tests to determine the learner's current proficiency and specific educational requirements. Based on these results, the adaptive content selection step enables the processing server 102 to select and customize educational materials that address identified knowledge gaps, with advanced algorithms analyzing historical data to optimize the selection process.

During simulated procedures, the real-time adjustment step allows the AI to monitor learner performance and dynamically modify instructional strategies and content using sensor data and continuous feedback loops for immediate remediation. Following simulations, the post-evaluation step involves conducting assessments, including adaptive multiple-choice questions, to measure progress and adjust future learning paths. This phase further incorporates scheduled durability tests administered at spaced intervals to ensure long-term retention, with predictive analytics applied to forecast future performance and recommend targeted interventions. This integrated approach enables the AI mentor to deliver effective, personalized educational experiences that evolve in real time with the learner's progress and performance.

In some embodiments, the processing server 102 can insert contents into the user-personalized training materials being transmitted to and/or accessed by the user computing devices 106A-106N. This insertion can be context-aware, such that the contents are relevant to the generated training content and do not disrupt the adaptive learning flow provided by the system's AI-driven modules. For example, the processing server 102 may insert banner content, video content, and/or other content items (including product, process, technic information, ads and the like) into the created knowledge-based content items. In embodiments, the contents inserted into the user-personalized training materials are relevant to the generated user-personalized training materials. For example, if the generated user-personalized training materials is a medical procedure, the processing server 102 can insert a banner content for a medical equipment. The processing server 102 can insert the content by generating an content request that includes a topic and/or subject of the generated user-personalized training materials and transmit the content request to the content server 110. The content server 110 can generate and/or identify a relevant content based on the content request and transmit the identified content to the processing server 102. In embodiments, the processing server 102 and/or the content server 110 can store in an content database contents that are tagged with certain keywords or contain metadata that enable to the processing server 102 and/or the content server 110 to identify relevant contents for insertion into the generated user-personalized training materials based on a topic and/or subject of the created knowledge-based content items. Embodiments can further utilize real-time analytics to dynamically match and insert contents that complement the training content.

In the system 100, a blockchain can be operated by the blockchain network 108. The blockchain network 108 can be comprised of a plurality of blockchain nodes 108. In embodiments, the processing server 102 can be a node in a blockchain network, e.g., the blockchain network 108. Further, while not illustrated in FIG. 1, the external data sources 104, the user computing devices 106, and/or the content server 110 can also be nodes in the blockchain network 108. Alternatively, the external data sources 104, the user computing devices 106, and/or the content server 110 can participate in the blockchain network via the processing server 102. The blockchain network 108 can be a rewards network that is integrated with the system 100. For example, the system 100 can incorporate a rewards mechanism designed to enhance user engagement and motivation. Participants (e.g., the users of the user computing devices 106) can earn points based on their performance and achievements within the training modules. For example, the users (e.g., the users of the user computing devices 106) in the system 100 can earn points for the assessment tests, the user-personalized training materials, the evaluation tests, and other interactions with the system 100. The rewards system further integrates blockchain-based NFTs as digital certificates of achievement, which are earned based on performance in adaptive simulations and assessments, thereby incentivizing continuous learning and excellence. Further, participants (e.g., the users of the user computing devices 106) can have the option to enhance their experience with the system 100 through a level-up mechanism by earning or purchasing additional points, allowing them to progress more quickly or access exclusive opportunities such as additional user-personalized training materials, reduced fees for participating in the system 100, personalized feedback, etc. Users (e.g., the users of the user computing devices 106) may choose to purchase points to reach higher levels or unlock premium content. Task completions and level-ups provide a sense of achievement and continuity in the user experience. Users (e.g., the users of the user computing devices 106) may exchange their accumulated points for tangible goods or services, such as access to advanced training materials, merchandise, or professional development opportunities. This exchange mechanism adds tangible value to the training experience, incentivizing continued participation. Further, participants (e.g., the users of the user computing devices 106) have the option to monetize their points, converting them into financial rewards. This feature provides an additional incentive for users (e.g., the users of the user computing devices 106) to engage deeply with the training content generated by the processing server 102 and strive for excellence. The system 100 can include a benefit selection period where participants (e.g., the users of the user computing devices 106) are allowed to choose from a curated set of rewards. For example, rewards can include, but are not limited to, catalog redemption rewards (redeem accumulated points or NFTs for items available in a digital or physical catalog, ranging from exclusive content to physical goods), marketplace rewards (users may have the option to sell or trade earned NFTs within a marketplace), etc. The system 100 can include a leaderboard (e.g., generated and stored by the processing server 102) that records and displays participant (e.g., the users of the user computing devices 106) rankings based on points earned. This transparent ranking system fosters a healthy competitive environment, encouraging participants (e.g., the users of the user computing devices 106) to excel and engage more fully with the training modules generated by the processing server 102. By integrating this multifaceted rewards system, the system 100 not only recognizes and incentivizes individual achievements but also promotes a culture of continuous improvement and excellence among participants (e.g., the users of the user computing devices 106).

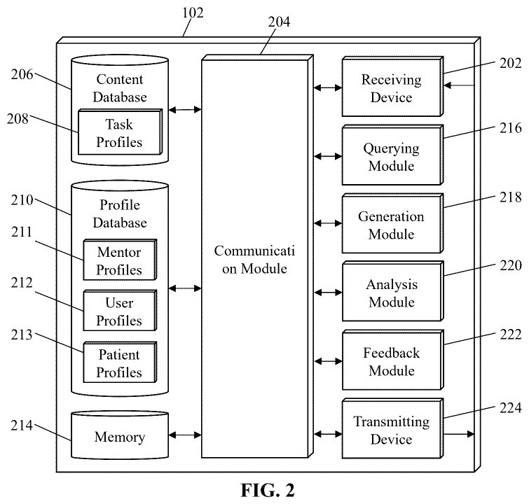

Each blockchain node can be a computing system, such as illustrated in FIGS. 2 or 5, discussed in more detail below, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain. While only a single blockchain network 108 is illustrated, it can be appreciated that any number of blockchain networks 108 can be a part of the system 100. In some cases, a single blockchain network 108 can manage a single blockchain and, in other cases, a blockchain network 108 can manage multiple blockchains.

The blockchain can be a distributed ledger that is comprised of at least a plurality of blocks. Each block can include at least a block header and one or more data values. Each block header can include at least a timestamp, a block reference value, and a data reference value. The timestamp can be a time at which the block header was generated and can be represented using any suitable method (e.g., UNIX timestamp, DateTime, etc.). The block reference value can be a value that references an earlier block (e.g., based on timestamp) in the blockchain. In some embodiments, a block reference value in a block header can be a reference to the block header of the most recently added block prior to the respective block. In an exemplary embodiment, the block reference value can be a hash value generated via the hashing of the block header of the most recently added block. The data reference value can similarly be a reference to the one or more data values stored in the block that includes the block header. In an exemplary embodiment, the data reference value can be a hash value generated via the hashing of the one or more data values. For instance, the block reference value can be the root of a Merkle tree generated using the one or more data values.

The use of the block reference value and data reference value in each block header can result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in each connected blockchain node in the blockchain network 108 prior to the generation and addition of a new block to the blockchain in order for the change to be made permanent. Computational and communication limitations can make such a modification exceedingly difficult, if not impossible, thus rendering the blockchain immutable.

In some embodiments, the blockchain can be used to store information regarding blockchain transactions conducted between two different blockchain wallets. A blockchain wallet can include a private key of a cryptographic key pair that is used to generate digital signatures that serve as authorization by a sender for a blockchain transaction, where the digital signature can be verified by the respective blockchain network 108 using the public key of the cryptographic key pair. In some cases, the term “blockchain wallet” can refer specifically to the private key. In other cases, the term “blockchain wallet” can refer to a computing device (e.g., processing server 102, and/or the user computing devices 106) that stores the private key for use thereof in blockchain transactions. For instance, each computing device can each have their own private key for respective cryptographic key pairs and can each be a blockchain wallet for use in transactions with the blockchain associated with the blockchain network. Computing devices in the blockchain network 108 can be any type of device suitable to store and utilize a blockchain wallet, such as a desktop computer, laptop computer, notebook computer, tablet computer, cellular phone, smart phone, smart watch, smart television, wearable computing device, implantable computing device, etc.

Each blockchain data value stored in the blockchain can correspond to a blockchain transaction or other storage of data, as applicable. A blockchain transaction can consist of at least: a digital signature of the sender of that is generated using the sender's private key, a blockchain address of the recipient of data generated using the recipient's public key, and a data identification, e.g., a blockchain currency amount or asset identification, that is transferred or other data being stored. In some blockchain transactions, the transaction can also include one or more blockchain addresses of the sender where blockchain currency and/or data is currently stored (e.g., where the digital signature proves their access to such currency), as well as an address generated using the sender's public key for any change that is to be retained by the sender. Addresses to which cryptographic currency and/or data has been sent that can be used in future transactions are referred to as “output” addresses, as each address was previously used to capture output of a prior blockchain transaction, also referred to as “unspent transactions,” due to there being currency and/or data sent to the address in a prior transaction where that currency and/or data is still unspent or unused. In some cases, a blockchain transaction can also include the sender's public key, for use by an entity in validating the transaction. For the traditional processing of a blockchain transaction, such data can be provided to a blockchain node in a blockchain network 108, either by the sender or the recipient. The node can verify the digital signature using the public key in the cryptographic key pair of the sender's wallet and also verify the sender's access to the data (e.g., that the unspent transactions have not yet been spent and were sent to address associated with the sender's wallet), a process known as “confirmation” of a transaction, and then include the blockchain transaction in a new block. The new block can be validated by other blockchain nodes in the blockchain network 108 before being added to the blockchain and distributed to all of the blockchain nodes in the blockchain network 108, respectively, in traditional blockchain implementations. In cases where a blockchain data value cannot be related to a blockchain transaction, but instead the storage of other types of data, blockchain data values can still include or otherwise involve the validation of a digital signature.

In the system 100, points and/or certificates of achievement can be converted into Non-Fungible Tokens (NFTs) stored on a blockchain in the blockchain network 108, providing participants (e.g., the users of the user computing devices 106) with unique digital assets that may represent certificates of achievement, badges, or other forms of recognition. These NFTs can be stored in digital wallets, showcasing the participant's accomplishments. The use of NFTs and blockchain technology in the system 100 enables a flexible, secure, and engaging reward system associated with task completion (e.g., completion of one or more user-personalized training materials generated by the processing server 102) within interactive learning or gamified environments. Thus, the system 100 provides participants (e.g., the users of the user computing devices 106) with opportunities to earn, trade, and redeem rewards, enhancing engagement and incentivizing progress within the system 100. In embodiments, blockchain integration supports transparent, tamper-proof tracking of rewards and cross-platform interoperability.

In embodiments, the blockchain network 108 can be utilized as a job marketplace. For example, the system 100 can utilize NFTs and blockchain technology to create a verifiable, secure, and flexible system for educational awards, which can be employed by both companies and individuals in the job search process. Thus, the system 100 offers significant advantages by allowing participants (e.g., the user of the user computing devices 106) to control the amount of information disclosed, ensuring privacy and relevance while enhancing trust and efficiency in hiring. Additionally, the invention can facilitate the creation of a job marketplace, providing a dynamic platform where candidates (e.g., users of the user computing devices 106) and employers (e.g., other users of the user computing devices 106) connect based on verified qualifications. For example, an employer (e.g., a user of the user computing device 106A) can leverage NFT/blockchain-based educational awards to streamline the recruitment process and identify a candidate (e.g., a user of the user computing device 106B) with specific skills and capabilities based on their completed user-personalized training materials. In the system 100, NFTs can serve as immutable proof of completed training or certifications, ensuring the authenticity of a candidate's (e.g., the user of the user computing device 106B) qualifications. The blockchain network 108 can allow a company (e.g., user of the user computing device 106A) to search for candidates (e.g., users of the user computing device 106B-N) who hold specific awards or have completed relevant training programs, enabling targeted recruitment for specialized roles. Also, an employer (e.g., the user of the user computing device 106A) can request access to candidates' (e.g., users of the user computing devices 106B-N) awards or certification data, which candidates can selectively grant, ensuring a focus on relevant qualifications without exposing unnecessary details. As an example, a company (e.g., a user of the computing device 106A) seeking a data scientist can filter candidates (e.g., users of the computing devices 106B-N) who hold NFTs representing verified completion of advanced AI or blockchain courses, ensuring that only qualified individuals are considered. On the other hand, for job seekers (e.g., users of the computing devices 106B-N), the NFT/blockchain-based educational awards of the system 100 provide a powerful tool to demonstrate their expertise and accomplishments in a secure, flexible way. For example, the NFTs enable candidates to carry verifiable credentials across platforms and regions, eliminating the need for manual verification. Further, candidates (e.g., users of the computing devices 106B-N) can choose which credentials to reveal, tailoring their profiles (e.g., the user profiles 212) to match job requirements while maintaining privacy over unrelated achievements. Thus, the system 100 enables users (e.g., users of the user computing devices 106) to share blockchain-backed certifications on professional platforms or during the application process, which helps those users stand out by showcasing verified qualifications. For example, an applicant (e.g., a user of the user computing device 106B) with multiple skills can present specific NFTs that align with the requirements of a desired role, simplifying the hiring process.

The blockchain of the blockchain network 108 can utilize smart contracts to streamline job offers and agreements between the users (e.g., the users of the user computing devices 106), ensuring transparency and efficiency in transactions between employers and candidates. For example, if a user profile (e.g., the user profile 112) of a candidate (e.g., a user of the user computing device 106B) contains user data that satisfies a job posting of an employer (e.g., a user of the user computing device 106A), a smart contract can generate a notification to the employer (e.g., a user of the user computing device 106A) of the user (e.g., a user of the user computing device 106B), or a smart contract can generate an notification to the user (e.g., a user of the user computing device 106B) notifying the user of the matching job posting, or a smart contract can generate an interview invitation to the user (e.g., a user of the user computing device 106B) for an interview with the employer (e.g., a user of the user computing device 106A). In embodiments, employers could participate in bidding systems for top talent, incentivizing highly skilled candidates to engage in the platform (e.g., the system 100). For example, a blockchain-enabled job marketplace (e.g., the blockchain network 108) allows a candidate (e.g., a user of the user computing device 106A), with verified NFTs for AI and machine learning certifications to connect with multiple companies (e.g., users of the user computing device 106B-N), looking for those specific skills. In such embodiments, employers (e.g., users of the user computing device 106B-N) can bid on or negotiate for the candidate's expertise, while the candidate retains control over the process.

The blockchain network 108 in the system 100 provides employer access to a pool of verified, highly skilled candidates, increased efficiency in filtering and identifying qualified individuals, and enhanced trust through immutable and fraud-proof credential verification. Further, the blockchain network 108 in the system 100 provides job candidates with a portable and verifiable digital record of qualifications, the ability to selectively disclose credentials for targeted applications, and new opportunities through participation in a blockchain-enabled job marketplace. Thus, the blockchain network 108 in the system 100 enables a secure, transparent, and efficient hiring process that bridges trust gaps while offering flexibility and control to all participants by incorporating NFTs and a blockchain transforming job searches and recruitment into a dynamic, privacy-focused, and efficient process, supported by verifiable qualifications and an interactive job marketplace.

In certain embodiments, the system 100 incorporates a marketplace for AI education, including user-personalized training materials. Through user computing devices 106A-106N, users may purchase or subscribe to AI courses and curricula. Additionally, the marketplace enables the licensing or deployment of AI educational modules as separate white-labeled properties for use by corporations or educational institutions. The marketplace is organized into three distinct sections: for educators, for learners, and for institutions. The educators section provides AI tools for course creation, including automated transcription, video archival with text, media classification based on a predefined taxonomy (i.e., a library), quiz generation, and the creation of role-based AI agents, as well as analytics dashboards that deliver AI-generated insights on course performance and student engagement. The learners section offers an AI-powered search and discovery function to help users find and enroll in relevant courses. The institutions section includes tools for developing and marketing complete curricula or degree programs, alongside AI-driven solutions for curriculum mapping and alignment with industry or job market requirements.

In exemplary embodiments, the processing server 102 is configured to collect and utilize feedback from users of the user computing devices 106A-106N to update and enhance the data and processes underlying the generation of user-personalized training materials. User feedback, transmitted via the communication network 120 using any suitable communication method, may pertain to any aspect of the content generation process, including but not limited to the accuracy and effectiveness of the generated training materials. In certain embodiments, stakeholders associated with a user's performance, such as employers, mentors, trainers, educators, customers, peers, and supervisors, may also provide feedback that is utilized by the processing server 102 to refine and improve its operations. For instance, the processing server 102 may generate one or more evaluation assessments to be administered after a user (e.g., a user of the user computing device 106A) has reviewed the personalized training materials, with the results stored in the respective user profile (212). In embodiments, real-time feedback is integrated with advanced analytics to continuously optimize the generation and delivery of training materials.

In certain embodiments, the processing server 102 is configured to store feedback provided by users of the user computing devices 106A-106N in the corresponding user profile (212). Additionally, system 100 incorporates adaptive assessments, including pre-simulation, post-simulation, and periodic multiple-choice evaluations, to continuously refine training content based on user feedback and performance data. The processing server 102 then leverages this stored feedback to dynamically generate and deliver user-personalized training materials tailored to each user's preferences. For example, feedback from one user may indicate a preference for interactive content with audio recordings featuring a specific tone and cadence, whereas feedback from another user may indicate a preference for concise slide decks without accompanying audio.

In embodiments, the processing server 102 is configured to generate user-personalized training materials specifically tailored to an individual's preferences based on historical feedback data. The processing server 102 may also incorporate feedback from other users with similar preferences to further refine the training content. In some embodiments, when a user initially interacts with the system to develop a user profile 212, the processing server 102 transmits a set of questions to the user computing device 106A to solicit preferences regarding content types, learning objectives, and related parameters. This initial interaction is further enhanced by adaptive questionnaires that dynamically refine the training content based on detailed user input. Additionally, the system 100 integrates adaptive assessments, comprising pre-simulation, post-simulation, and spaced multiple-choice evaluations, to continuously update and optimize training content based on user feedback and performance data.

The methods and systems disclosed herein provide an innovative approach for creating and managing user-personalized training content using generative artificial intelligence (AI). In embodiments, the system leverages advanced machine learning and other techniques to ingest subject matter expert (SME) materials and user performance data, thereby generating tailored training content with minimal user interaction. This approach obviates the need for labor-intensive, individualized training, as each user receives content specifically adapted to their unique needs and learning preferences.

Furthermore, the integration of generative AI in both content creation and the incorporation of real-time user feedback ensures that the personalized training content remains current and is presented in the most effective format for the user, thereby significantly enhancing the overall effectiveness compared to traditional methods of content delivery. Additionally, the system incorporates live simulation capabilities with adaptive assessments and real-time multimedia instructional augmentation, which together enhance knowledge retention and improve decision-making abilities. Thus, the disclosed methods and systems offer a comprehensive, scalable solution for delivering highly effective and personalized training experiences.

In embodiments, the disclosed methods and systems facilitate real-time verbal exchanges to create a natural, fluid training experience. Users interact with the AI via spoken dialogue, and when combined with multimedia elements such as graphics and video, these voice interactions provide a deeper level of immersion by visually representing complex scenarios or reinforcing spoken content. Consequently, the system 100 delivers a scalable, real-time training solution that maintains consistency across all user interactions without sacrificing quality or realism. By integrating advanced voice technology with visual and video elements, the system enhances both the fidelity and interactivity of simulation-based training. This multi-modal approach enables developers to create fully immersive, adaptive training environments that foster verbal, visual, and situational skills, thereby preparing participants for real-world scenarios.

Moreover, the disclosed methods and systems provide an agentic, multi-modal AI mentor that dynamically integrates knowledge and feedback from a diverse array of SMEs, enhancing learning environments such as surgical simulators. The system 100 auto-generates adaptive multiple-choice assessments and scenario variations that are continuously refined based on user performance feedback. Operating as an intelligent, adaptive guide, the AI mentor directs trainees through structured tasks and objectives while simulating realistic, context-aware interactions. It facilitates live, interactive simulations featuring multiple pre-and post-evaluative assessments and dynamically generates adaptive multiple-choice questions to measure and reinforce cognitive skill development.

Agentic systems, as disclosed herein, analyze user data in real time to tailor experiences, ensuring interactions are personalized and intuitive. These systems provide users with content, products, or services based on their preferences, behaviors, and goals, and adjust interfaces or workflows to match user skill levels or objectives, thereby optimizing engagement and satisfaction. The system 100 further enables real-time, adaptive, multi-agent interactions wherein the simulation dynamically adjusts based on the learner's inputs, incorporating contextual instructional overlays retrieved via RAG. Enhanced algorithms predict user needs based on historical interaction patterns, and agentic AI acts as a decision-making assistant by synthesizing complex data and offering actionable insights, evaluating multiple strategies, recommending optimal solutions, and anticipating potential issues while notifying stakeholders with suggested resolutions.

For example, agentic AI can autonomously adapt features based on real-time conditions, continuously learn from user feedback to improve functionality without manual updates and automate repetitive tasks, thus optimizing processes and workflows while forecasting resource needs and allocating resources to prevent bottlenecks. Integration with AI-powered analytics further refines these processes. Additionally, agentic AI facilitates natural, meaningful interactions between users and company platforms or representatives by enabling seamless conversation via natural language processing, supporting multi-modal engagement through voice, text, and visual inputs, and even accommodating augmented reality and gesture-based inputs.

Benefits of agentic AI include scalability, allowing autonomous operation across multiple touchpoints without proportional increases in resources, real-time adaptability to shifts in user needs or market trends, enhanced engagement and long-term loyalty through personalized experiences, and market differentiation by positioning products as innovative and responsive. The system 100 leverages continuous learning algorithms and dynamic resource allocation to further enhance real-time adaptability.

Embodiments of the present disclosure enable agentic AI to deliver personalized user experiences through: (1) dynamic recommendations based on real-time analysis of user behavior, preferences, and goals; (2) context adaptation, where interfaces and workflows automatically adjust to match user skill levels or specific objectives; (3) decision-support systems that synthesize complex data to offer actionable insights, scenario analyses, and proactive alerts; (4) intelligent product features that render products more responsive and self-learning; (5) process automation and optimization that support real-time, multi-agent interactions and automate repetitive tasks while forecasting and allocating resources; and (6) interactive engagements that leverage natural language processing to facilitate seamless, meaningful dialogue, support augmented reality, and structure the learning experience into layered objectives, ranging from high-level goals to mid-level tasks and low-level actions, thereby enabling modular, progressive skill acquisition and ensuring alignment of tasks and objectives across varying complexity levels.

Furthermore, the AI mentor employs multi-modal inputs and outputs to deliver an interactive, adaptive learning experience, including real-time visual feedback for error detection, conversational interactions via natural language processing, and haptic and auditory cues to simulate realistic conditions. By integrating insights from multiple SMEs, the system can simulate realistic, nuanced scenarios reflecting diverse expert inputs, allowing the AI mentor to adapt guidance to best practices across various domains, simulate multi-disciplinary collaboration scenarios, and deliver continuously updated training experiences based on evolving SME input. The agentic, multi-modal system disclosed herein (e.g., the system 100) thus offers a flexible, scalable platform for enhancing hierarchical learning environments while accommodating a wide range of use cases and training objectives.

### Processing Server

FIG. 2 depicts an exemplary embodiment of a processing server 102 within system 100. FIG. 2 also depicts integrated adaptive learning modules, real-time analytics, and multi-modal data fusion that enhance the dynamic personalization (including a case parameterization module) of training content. Further, FIG. 2 details the integration of advanced machine learning components, LLM modules, and multi-agent orchestration frameworks (e.g., LangGraph©) that enable adaptive, real-time content generation. In embodiments, system 100 is configured to securely manage corporate integrations (e.g., with Workday©, Salesforce©) by employing robust encryption, role-based access control, and standardized application programming interfaces (APIs), thereby ensuring that sensitive training and performance data remains protected. The processing server 102 is further configured to facilitate real-time data exchange for adaptive simulations and to integrate multimedia content sourced via retrieval-augmented generation (RAG), wherein such content is annotated by AI and subsequently verified by SMEs for instructional significance. The processing server 102 may operate as any suitable component within system 100, including, without limitation, the processing server 102 itself, external data sources 104A-104N, user computing devices 106A-106N, and/or the content server 110. It will be apparent to those skilled in the art that the embodiment of processing server 102 illustrated in FIG. 2 is provided for illustrative purposes only and is not intended to limit the scope of possible configurations for performing the functions described herein. For example, the computer system 500 illustrated in FIG. 5, and discussed in further detail below, represents one suitable configuration of the processing server 102.

The processing server 102 can include a receiving device 202. The receiving device 202 can be configured to receive data over one or more networks via one or more network protocols. In some instances, the receiving device 202 can be configured to receive data from the external data sources 104A-104N, the user computing devices 106A-106N, the content server 110, and other systems and entities via one or more communication methods, such as radio frequency, local area networks, wireless area networks, cellular communication networks, Bluetooth, the Internet, etc. (e.g., the network 120). In some embodiments, the receiving device 202 can be comprised of multiple devices, such as different receiving devices for receiving data over different networks, such as a first receiving device for receiving data over a local area network and a second receiving device for receiving data via the Internet. The receiving device 202 can receive electronically transmitted data signals, where data can be superimposed or otherwise encoded on the data signal and decoded, parsed, read, or otherwise obtained via receipt of the data signal by the receiving device 202. In some instances, the receiving device 202 can include a parsing module for parsing the received data signal to obtain the data superimposed thereon. For example, the receiving device 202 can include a parser program configured to receive and transform the received data signal into usable input for the functions performed by the processing device to carry out the methods and systems described herein.

The receiving device 202 can be configured to receive data signals electronically transmitted by external data sources 104 that can be superimposed or otherwise encoded with SME materials, user data, and other materials that can be classified, indexed, analyzed, and ingested by the processing server 102 and used in the generation of user-personalized training materials. The receiving device 202 can also be configured to receive data signals electronically transmitted by the user computing devices 106A-N, which can be superimposed or otherwise encoded with user profiles, requests for user-personalized training materials, feedback data, etc. The receiving device 202 can also be configured to receive data signals electronically transmitted by the content server 110, which can be superimposed or otherwise encoded with contents.

The processing server 102 can also include a communication module 204. The communication module 204 can be configured to transmit data between modules, engines, databases, memories, and other components of the processing server 102 for use in performing the functions discussed herein. The communication module 204 can be comprised of one or more communication types and utilize various communication methods for communications within a computing device. For example, the communication module 204 can be comprised of a bus, contact pin connectors, wires, etc. In some embodiments, the communication module 204 can also be configured to communicate between internal components of the processing server 102 and external components of the processing server 102, such as externally connected databases, display devices, input devices, etc. The processing server 102 can also include one or more processing devices. The processing device(s) can be configured to perform the functions of the processing server 102 discussed herein as will be apparent to persons having skill in the relevant art. In some embodiments, the processing device(s) can include and/or be comprised of a plurality of engines and/or modules (e.g., specifically configured hardware) specially configured to perform one or more functions of the processing device, such as the querying module 216, the generation module 218, the analysis module 220, and the feedback module 222, etc. As used herein, the term “module” can be software executable on hardware particularly programmed to receive an input, perform one or more processes using the input, and provides an output. The input, output, and processes performed by various modules will be apparent to one skilled in the art based upon the present disclosure.

The processing server 102 can also include a content database 206. The content database 206 can be configured to store a plurality of SME materials in one or more task profiles 208 using a suitable data storage format and schema. The content database 206 can be a relational database that utilizes structured query language for the storage, identification, modifying, updating, accessing, etc. of structured data sets stored therein. Each task profile 208 can be stored along with any associated index data, metadata, classification data, subject identifier, etc., and can include SME materials received from external data sources 104a-104N. In embodiments, the content database 206 is integrated with vector search capabilities and knowledge graph linkages to enhance content retrieval and context-aware indexing.

The processing server 102 can also include a profile database 210. The profile database 210 can be configured to store one or more user profiles 212 using a suitable data storage format and schema. The profile database 210 can be a relational database that utilizes structured query language for the storage, identification, modifying, updating, accessing, etc. of structured data sets stored therein. Each user profile 212 can be a structured data set configured to store data related to a user, which can include user identification, user preferences, user media which can include or be in the exclusive form of audio and/or text feedback data, user computing device 106 communication data, etc. Embodiments can also include integration with external data sources (e.g., the external data sources 104A-104N) for real-time user performance analytics and cross-platform profile synchronization.

The processing server 102 can also include a memory 214. The memory 214 can be configured to store data for use by the processing server 102 in performing the functions discussed herein. The memory 214 can be configured to store data using suitable data formatting methods and schema and can be any suitable type of memory, such as read-only memory, random access memory, etc. The memory 214 can include, for example, encryption keys and algorithms, communication protocols and standards, data formatting standards and protocols, program code for modules and application programs of the processing device, and other data that can be suitable for use by the processing server 102 in the performance of the functions disclosed herein as will be apparent to persons having skill in the relevant art. In some embodiments, the memory 214 can be comprised of or can otherwise include a relational database that utilizes structured query language for the storage, identification, modifying, updating, accessing, etc. of structured data sets stored therein. For example, the memory 214 can be configured to store machine learning models, natural language processing data, algorithms and data for generative artificial intelligence (AI), etc. In embodiments, the memory 214 is further enhanced to support rapid model inference and real-time data caching for low-latency processing.

The system further integrates a retrieval-augmented generation (RAG) engine which, in conjunction with a plurality of agentic AI personas, dynamically retrieves, annotates, and incorporates external multimedia assets, including images, audio and/or text-based media, and articles, into the user-personalized training content. The agentic AI personas, operating under predefined prompts and interacting in real time, facilitate the contextual enrichment and adaptive refinement of the retrieved assets. In one embodiment, subject matter experts (SMEs) validate and further annotate these external assets through an inline annotation interface, thereby ensuring that the augmented training content remains accurate, comprehensive, and continuously aligned with current best practices.

In exemplary embodiments, the processing server 102 includes a querying module 216 configured to execute queries on various databases to retrieve information. The querying module 216 accepts one or more data values or query strings and executes these queries on a designated database, such as the content database 206, to identify and extract stored information. The retrieved information is then routed to an appropriate engine or module within the processing server 102. For instance, the querying module 216 may query the profile database 210 to identify a user profile 212 associated with a content request, thereby enabling the system to tailor knowledge-based content items based on user preferences. In certain embodiments, the querying module 216 employs semantic search and natural language query processing techniques to enhance the precision and relevance of the query results.

Additionally, the processing server 102 may incorporate a generation module 218 configured to produce various data outputs necessary for system functionality. The generation module 218 is responsible for creating adaptive multiple-choice assessments and live simulation scenarios that integrate real-time, AI-driven instructional overlays derived from dynamically retrieved multimedia content. It accepts instructions as input, generates data accordingly, and outputs this data to one or more modules within the processing server 102. For example, the generation module 218 may generate task profiles 208, user profiles 212, patient profiles 213, user-personalized training materials, notification messages, user interfaces, and feedback questionnaires. Furthermore, the generation module 218 can employ a generative AI model in combination with a multi-agent framework to create training materials tailored to a specific subject or task. This framework leverages agentic AI personas, which dynamically interact based on user preferences stored in user profile 212, to enable real-time, context-sensitive adaptations of the generated content. Moreover, the generation module 218 is capable of producing transcripts for user-personalized training materials (e.g., audio transcripts for video content) to enhance content accessibility and facilitate review. In certain embodiments, the generation module 218 also supports multi-modal content synthesis, integrating text, video, and interactive elements into cohesive, immersive training experiences.

The processing server 102 can also include an analysis module 220. The analysis module 220 can be configured to perform data analysis for the processing server 102 as part of the functions discussed herein. The analysis module 220 can receive instructions as input, can perform data analysis as instructed, and can output a result of the data analysis to one or more modules of the processing server 102. In some cases, the input can include the data to be analyzed and/or data to be used in the analysis. In other cases, the analysis module 220 can be configured to identify such data, such as in the database 206, the profile database 210, and/or memory 214. The analysis module 220 can be configured to, for example, analyze SME materials, task profiles 208, user profiles 212, patient profiles 213, etc. Embodiments can integrate predictive analytics and machine learning-based trend analysis to derive actionable insights from the data.

The processing server 102 can also include a feedback module 222. The feedback module 222 can be configured to collect and process feedback for the processing server 102 as part of the functions discussed herein. The feedback module 222 can receive instructions as input, can collect or process feedback as instructed, and can output a result of the collection or processing to one or more modules of the processing server 102. In some cases, the input can include the feedback data to be processed and a request for feedback to be collected. The feedback module 222 can be configured to collect feedback from the user computing devices 106A-106N regarding served user-personalized training materials and process the feedback to update user preferences in user profiles 212, provide data to the generation module 218 to update user-personalized training materials, provide data to the generation module 218 for use in training the generative AI, etc. In embodiments, the feedback module 222 incorporates real-time sentiment analysis and natural language understanding to refine the training material generation process continuously.

The processing server 102 can also include a transmitting device 224. The transmitting device 224 can be configured to transmit data over one or more networks via one or more network protocols. In some instances, the transmitting device 224 can be configured to transmit data to the one or more external data sources 104A-104N, the user computing devices 106A-106N, the content server 110, and other entities via one or more communication methods, local area networks, wireless area networks, cellular communication, Bluetooth, radio frequency, the Internet, etc. (e.g., the network 120). In some embodiments, the transmitting device 224 can be comprised of multiple devices, such as different transmitting devices for transmitting data over different networks, such as a first transmitting device for transmitting data over a local area network and a second transmitting device for transmitting data via the Internet. The transmitting device 224 can electronically transmit data signals that have data superimposed that can be parsed by a receiving computing device. In some instances, the transmitting device 224 can include one or more modules for superimposing, encoding, or otherwise formatting data into data signals suitable for transmission. Furthermore, the system 100 integrates advanced multimedia protocols that support dynamic content overlays and interactive signal encoding, as disclosed in the UX/UI framework.

The transmitting device 224 is configured to electronically transmit data signals to one or more external data sources 104A-104N, wherein these signals are superimposed or otherwise encoded with requests for SME materials and additional resources that can be delivered either in parallel or sequentially. Additionally, the transmitting device 224 is configured to send data signals to the user computing devices 106A-106N containing the generated user-personalized training materials, questionnaires, notification messages, and user data requests. Notably, the use of retrieval-augmented generation (RAG) techniques, combined with an agentic framework, ensures that the transmitted content remains both current and contextually relevant by dynamically adapting to real-time SME input and user performance feedback.

### Process for Creating and Managing User-Personalized Training Content

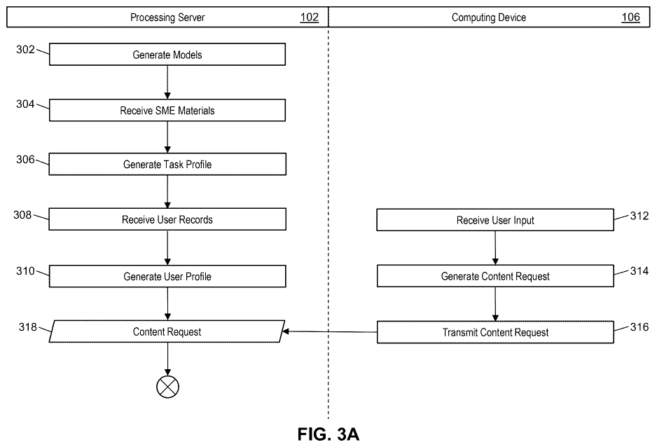

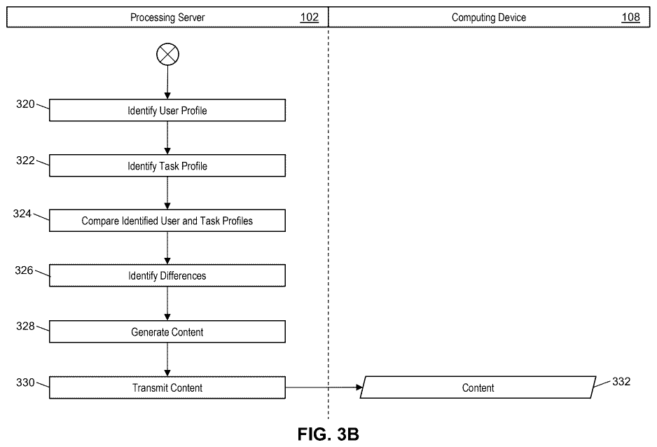

FIGS. 3A and 3B illustrate process 300 in system 100 of FIG. 1 for creating and delivering user-personalized training content to a user computing device 106 via the processing server 102. The diagrams further detail additional steps, including real-time performance monitoring, gap analysis, and the integration of adaptive feedback, that collectively enhance the dynamic personalization and continuous refinement of training content based on user performance and contextual data analysis. The process 300 leverages a multi-agent simulation framework to enhance the learning experience. In step 302, the generation module 218 of the processing server 102 generates machine learning models used to produce user-personalized training materials based on data available to the system. For example, the processing server 102 may train a generative AI model using SME materials stored in task profiles 208 and user performance data contained in user profiles 212. In some embodiments, the processing server 102 generates discrete machine learning models for each subject represented in the task profiles 208 or, alternatively, a single comprehensive model that is agnostic to subject matter.

In step 304, the receiving device 202 of the processing server 102 retrieves a plurality of SME materials from external data sources 104A-104N via the communication network 120 using any suitable communication method. The analysis module (220) then processes and ingests these SME materials using retrieval-augmented generation (RAG) and/or corrective RAG (CRAG) techniques, which include extracting metadata, indexing, and classifying the received content. In certain embodiments, the SME materials encompass dynamically retrieved multimedia assets via RAG that are annotated for instructional relevance.

Moreover, system 100 employs an AI-driven, agentic conversational workflow wherein multiple specialized AI agents engage in structured, multi-pass dialogues to capture, structure, and refine SME expertise. This agentic workflow further enriches the training material generation process by integrating diverse expert inputs into the AI mentor's knowledge base.

In step 306, the generation module 218 of the processing server 102 processes the subject matter expert (SME) materials to generate one or more task profiles 208, which are then stored in the content database 206. For example, the processing server 102 may create a distinct task profile 208 for each unique subject or task identified within the analyzed SME materials. Each task profile 208 is assigned a unique subject identifier that indexes the specific subject matter or task represented by the SME materials. In embodiments, the processing server 102 further tags each individual SME material with its corresponding subject identifier to facilitate efficient categorization and retrieval. This automated tagging process is supported by an LLM-agnostic integration layer that leverages natural language processing techniques to accurately index and classify SME knowledge for subsequent use in generating personalized training content.

In step 308, the processing server 102 receives user data from one or more user computing devices 106A-106N, as described above. In step 310, the processing server 102 generates one or more user profiles 212 and stores them in the profile database 210. This user profiling mechanism is enhanced by dynamic data capture techniques that continuously update and refine user profiles, thereby enabling the adaptive learning modules to deliver highly personalized training experiences.

In step 312, the user computing device 106A can receive input from a user thereof, which can include a content request for user-personalized training content. The request can include a user identifier and a subject identifier identifying the specific topic and/or task the user wishes to receive user-personalized training content for. In step 314, the user computing device 106A can electronically transmit the request for user-personalized training content to the processing server 102 using the communication network 120 using any suitable communication method in step 316. In step 318, the receiving device 202 of the processing server 102 can receive the request for user-personalized training content. This interactive request mechanism is further bolstered by real time feedback and adaptive branching.

In step 320, the analysis module 220 of the processing server 102 can identify a user profile 212 of the one or more user profiles 212 stored in the profile database 210 that includes a user identifier matching the user identifier included in the request. Identifying the user profile 212 can include the querying module 216 executing a query on the profile database 210 to identify the user profile 212 that includes the user identifier included in the request. Advanced query mechanisms ensure prompt and accurate identification of user profiles.

In step 322, the analysis module 220 of the processing server 102 can identify a task profile 208 of the one or more task profiles 208 stored in the database 206 that includes a subject identifier matching the subject identifier included in the request. Identifying the task profile 208 can include the querying module 216 executing a query on the database 206 to identify the task profile 208 that includes the subject identifier included in the request. This targeted retrieval of task profiles is augmented by automated indexing and metadata extraction techniques, enhancing the efficiency of content personalization.

In step 324, the analysis module 220 of the processing server can compare the one or more SME materials of the identified task profile 208 and the one or more user records of the identified user profile 212 having a subject identifier matching the subject identifier included in the request. In step 326, the analysis module 220 of the processing server can identify one or more differences between the one or more SME materials of the identified task profile 208 and the one or more user records of the identified user profile 212 having a subject identifier matching the subject identifier included in the request. The comparative analysis employs advanced machine learning algorithms to pinpoint discrepancies, thereby tailoring content to address specific learner needs.

In step 328, the generation module 218 of the processing server 102 generates one or more user-personalized training materials by analyzing differences between the SME training materials contained in the identified task profile 208 and the user records associated with the identified user profile 212 that are tagged with a corresponding subject identifier. In one embodiment, a generative AI model, operating in conjunction with an agentic, multi-pass framework that captures comprehensive SME workflows and decision points via structured interviews, is employed to create training content specifically tailored to the user's preferences, as indicated by the content request and/or stored in the user profile 212. This process is further enhanced by a modular simulation engine, which may be deployed in a cloud-based, on-premises, or hybrid environment, that integrates multi-agent input and dynamically communicates simulation cues to adjust the generated content in real time. Additionally, retrieval-augmented generation (RAG) techniques are used to overlay multimedia instructional content, and adaptive multiple-choice assessments are generated and administered pre-simulation, post-simulation, and at spaced intervals to continuously evaluate and enhance learner performance.

In step 330, the transmitting device 224 of the processing server 102 is configured to electronically transmit the user-personalized training materials to the user computing device 106A in response to the received request. This transmission can occur over an on-premises network, via an online connection, or through a hybrid deployment, utilizing optimized network protocols to ensure minimal latency and high data integrity in accordance with advanced communication strategies.

In step 332, the user computing device 106A can receive the user-personalized training materials from the processing server 102 via the communication network 120 using any suitable communication method. The receiving process is designed to be robust, supporting a variety of communication methods, as detailed in the UX/UI framework.

### Exemplary Method for Creating and Managing User-Personalized Training Content

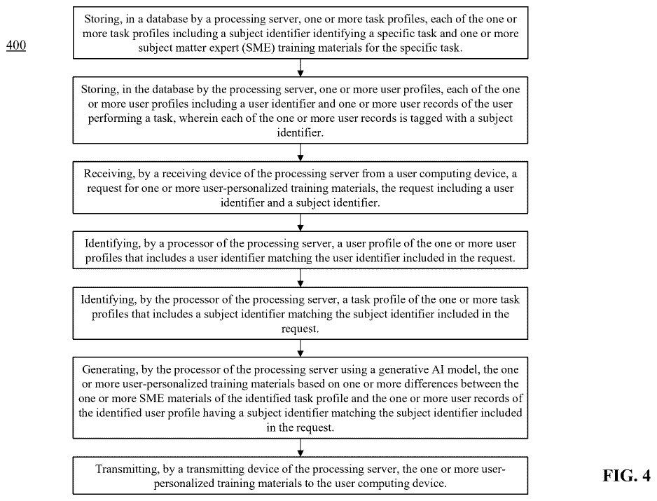

FIG. 4 illustrates a method 400 for creating and managing user-personalized training content using generative artificial intelligence (AI). The method 400 embodies the integration of SME captured expertise with adaptive, AI driven content generation techniques. The flow chart of FIG. 4 further discloses the application of retrieval-augmented generation (RAG) techniques to dynamically integrate multimedia instructional content and contextual data, and the use of multi-agent simulation frameworks to create interactive, role-based training scenarios. In these scenarios, simulated agents provide real-time feedback and adaptive instruction based on continuous performance monitoring and gap analysis, thereby iteratively refining the training content to optimize learning outcomes.

In step 402, one or more task profiles (e.g., task profiles 208) are stored in a database (e.g., the content database 206) of the processing server 102. Each task profile includes at least a subject identifier corresponding to a specific task and one or more subject matter expert (SME) training materials for that task. In one embodiment, the SME training materials are derived from structured, multi-pass interviews conducted by agentic AI personas that capture detailed workflows and decision trees. These interviews use advanced large language models (LLMs) to extract both the sequential steps and critical decision points from SME input, which are then encoded into flow-chart representations and integrated with retrieval-augmented generation (RAG) techniques. The resulting SME training materials may comprise various multimedia formats, including video, diagrams, illustrations, textbooks, articles, audio files, and three-dimensional simulations, as well as dynamic, scenario-based interactive training modules. The specific task may be, for example, a surgical or medical procedure, aircraft or spacecraft operation, emergency response training, crisis management, structural or civil engineering, or project management task. Moreover, the system 100 supports the generation of educational content in multiple modalities, including audio-only simulations, video simulations, and 3D interactive simulations, thereby accommodating a wide range of training needs and preferences while ensuring high fidelity, auditable, and contextually relevant instructional materials.

In step 404, the processing server 102 stores one or more user profiles (e.g., user profiles 212) in a designated database (e.g., the profile database 210). Each user profile comprises at a minimum a unique user identifier and one or more user records capturing the user's performance of a task, wherein each media element, whether in audio, text, or a combination thereof, is tagged with a subject identifier. Furthermore, these user profiles are indexed using advanced metadata tagging techniques to ensure efficient retrieval and maintain contextual relevance.

In step 406, a request for one or more user-personalized training materials can be received by a receiver (e.g., receiving device 202) of a processing server (e.g., processing server 102) from a user computing device (e.g., user computing device 106A). The request includes at least a user identifier and a subject identifier. This request mechanism is further enhanced by real time adaptive feedback protocols, to ensure the training content aligns with the learner's needs.

In step 408, a processor (e.g., the querying module 216) of the processing server (e.g., the processing server 102) can identify a user profile of the one or more user profiles (e.g., user profiles 212) that includes a user identifier matching the user identifier included in the request. For example, the processor (e.g., the querying module 216) of the processing server (e.g., the processing server 102) can execute a query on a database (e.g., the profile database 210) to identify a user profile (e.g., the user profile 212) that includes a user identifier matching the user identifier included in the request. Such precise matching is bolstered by dynamic data indexing which facilitate rapid identification of relevant user profiles.

In step 410, the querying module 216 of the processing server 102 identifies a task profile from the stored task profiles 208 by matching the subject identifier included in the request. In one embodiment, the processor executes a query on the content database 206 to retrieve not only the task profile corresponding to the subject identifier but also its associated structured knowledge workflow, comprising flowcharts, decision trees, and metadata tags, derived from multi-pass agentic SME interviews. This targeted retrieval leverages these decision-tree structures and automated tagging mechanisms to ensure that the most pertinent and contextually enriched task profile is selected, thereby facilitating the generation of highly tailored user-personalized training materials.

In step 412, the generation module 218 of the processing server 102 generates one or more user-personalized training materials using a generative AI model. This process is driven by a detailed comparison between the SME training materials contained in the identified task profile 208, and which have been augmented through structured, multi-pass, agentic SME interviews that capture comprehensive workflows, decision points, and decision trees, and the user records stored in the identified user profile 212 that bear the corresponding subject identifier. The analysis module 220 systematically identifies discrepancies and performance gaps, thereby determining targeted areas for improvement. Based on these differences, the generative AI model produces adaptive training content that can manifest as a three-dimensional simulation video, an augmented reality simulation, or even an audio-only simulation environment, all designed to provide real-time, interactive feedback during task performance. In embodiments, this generation process is further enhanced by real-time multimedia retrieval techniques, including retrieval-augmented generation (RAG), and by the dynamic creation of adaptive, AI-generated multiple-choice assessments to continuously evaluate and improve learner performance. Moreover, advanced object identification and motion analysis techniques are employed to detect user-manipulated objects and their movements, ensuring that the personalized training materials accurately address identified performance gaps and align with the established best practices.

In step 414, the one or more user-personalized training materials are transmitted by a transmitting device (e.g., the transmitting device 224) of the processing server (e.g., the processing server 102) to the user computing device (e.g., the user computing device 106A). This transmission may occur over on-premises networks, online connections, or a hybrid deployment, utilizing optimized network protocols as described in the UX/UI framework to ensure high data integrity and minimal latency. In embodiments, the transmission is synchronized with dynamic, agentic cues generated by the multi-agent system, thereby ensuring that the delivered training materials and any real-time simulation adjustments are contextually relevant and immediately responsive to the learner's performance.

In some embodiments, the method 400 further includes generating a generative AI model using a processor (e.g., the generation module 218) of the processing server 102. This model generation comprises: (i) inputting the SME materials from one or more task profiles (e.g., task profiles 208) associated with a first subject identifier into the generative AI model; (ii) inputting one or more user records from one or more user profiles (e.g., user profiles 212) that bear a subject identifier matching the first subject identifier; and (iii) training the generative AI model based on these combined inputs. In embodiments, the process is further enhanced by integrating a multi-agent framework that conducts structured, multi-pass SME interviews to capture comprehensive workflows, decision trees, and key performance data in real time, and by leveraging retrieval-augmented generation (RAG) techniques to incorporate external multimedia content. The resulting generative AI model, further informed by these agentic SME and RAG content capture processes, is then employed to produce highly personalized training materials and adaptive simulation content. Such training materials may include static outputs (e.g., standard operating procedures and educational review documents) as well as dynamic, interactive simulation environments, which can manifest in audiovisual, audio-only, or three-dimensional formats. This model generation is supported by scalable architectures that can be deployed in cloud-based, on-premises, or hybrid environments, thereby ensuring robust and adaptive learning outcomes.

In some embodiments, the method 400 further includes storing in a database (e.g., the profile database 210) by the processing server (e.g., the processing server 102) one or more mentor profiles (e.g., the mentor profiles 211). Each mentor profile comprises a trained generative AI persona associated with a specific task profile (e.g., task profiles 208), wherein the AI persona functions as a virtual avatar of a subject matter expert (SME) for that task. The generation of user-personalized training materials further includes identifying, via the querying module of the processing server 102, one or more mentor profiles corresponding to the identified task profile, and subsequently generating, via the generation module 218, one or more AI mentors by analyzing the differences between the SME materials of the task profile, the user records of the identified user profile (e.g., user profile 212), and the information contained in the mentor profiles. The resulting AI mentors are then incorporated into the user-personalized training materials, which may be output in various formats, including video, audio-only simulations, or three-dimensional interactive simulations, to provide an immersive, agent-driven instructional experience.

In some embodiments, the method 400 further includes retrieving, by a processor (e.g., the generation module 218) of a processing server (e.g., the processing server 102), new SME training materials for each specific task represented in one or more task profiles (e.g., task profiles 208). The generation module 218 continuously or periodically queries both external data sources and internal repositories, leveraging retrieval-augmented generation (RAG) techniques as well as insights obtained from multi-pass, agentic SME interviews, to acquire the most current and comprehensive SME materials. Based on these newly retrieved materials, the processor updates the corresponding task profiles in the content database 206, thereby ensuring that the stored SME knowledge remains current, reflective of evolving industry standards, and capable of supporting dynamic content personalization and adaptive training outcomes.

In some embodiments, the method 400 further includes identifying differences between the SME materials of the identified task profile and the user records of the identified user profile that are associated with the matching subject identifier. This identification is performed by a processor (e.g., the analysis module 220) of the processing server 102, which first detects one or more user-manipulated objects present in both the SME materials of the task profile (e.g., task profile 208) and the corresponding user records (e.g., user profile 212) using object identification techniques. The processor then compares the movements of these objects in the SME materials to their movements in the user records. This comparative analysis, enhanced by advanced tracking and analytical features, ensures high-fidelity assessments of user performance by accurately pinpointing discrepancies between the expert-recommended procedures and the actual user actions.

In some embodiments, the generation module 218 of the processing server 102 produces one or more user-personalized training materials by generating dynamic annotations based on identified differences between the SME training materials (derived via structured, multi-pass agentic interviews that capture workflows and decision trees) and the corresponding user records of the identified user profile 212, which bear a matching subject identifier. These annotations are then integrated into the user records, enabling the creation of training content that reflects both expert guidance and real-time performance feedback. In embodiments where the specific task is a medical procedure, the system further stores patient profiles (e.g., patient profiles 213) in the profile database 210, with each profile including a unique patient identifier and associated patient data. When a request includes a patient identifier, the querying module 216 retrieves the corresponding patient profile, and the generated training materials are further tailored to incorporate this patient data. For example, the personalized training materials may comprise a simulated video, delivered in audiovisual, audio-only, or three-dimensional interactive formats, depicting the medical procedure performed on the patient specified by the patient identifier. This integration of patient data, dynamic annotations, and agentic, multi-pass SME inputs, augmented by retrieval-augmented generation (RAG) techniques, ensures that the training materials are both personalized and clinically relevant, while supporting adaptive, context-sensitive learning strategies.

In some embodiments, the processing server 102, via its receiving device (e.g., device 202), receives the request in real time and concurrently collects user data from one or more remote sensor devices. This data is stored in the profile database 210 under the corresponding user profile (e.g., user profile 212). The processing server 102 then dynamically generates user-personalized training materials based on this up-to-date sensor input and transmits them to the user computing device (e.g., device 106A) in real time. This continuous integration of remote sensor data enables the system to adapt the training content dynamically, ensuring that the instructional materials accurately reflect the user's current performance metrics.

In some embodiments, the processing server 102, via its receiving device (e.g., device 202), receives the request in real time and concurrently collects user data from one or more remote sensor devices. This data is stored in the profile database 210 under the corresponding user profile (e.g., user profile 212). The processing server 102 then dynamically generates user-personalized training materials based on this up-to-date sensor input and transmits them to the user computing device (e.g., device 106A) in real time. This continuous integration of remote sensor data enables the system to adapt the training content dynamically, ensuring that the instructional materials accurately reflect the user's current performance metrics.

In some embodiments, the generated new knowledge-based materials are transmitted by a transmitting device (e.g., the transmitting device 224) of the processing server (e.g., the processing server 102) to the computing device (e.g., the computing device 108). The knowledge-based materials may comprise any combination of text, video, podcasts, interactive media, or other suitable formats. In certain embodiments, the method further includes receiving feedback data, such as user interactions, performance metrics, and qualitative assessments, associated with the generated materials. This feedback is processed by a dedicated feedback module (e.g., feedback module 222) and used to update a comprehensive knowledge map via advanced, agentic multi-pass techniques that integrate inputs from structured SME interviews and retrieval-augmented generation (RAG). The analysis module (e.g., analysis module 220) then identifies any gaps within the updated knowledge map, and the generation module (e.g., generation module 218) revises the curriculum plan accordingly, generating updated knowledge-based material items using a generative AI model. These updated materials are then transmitted to the computing device, thereby establishing a comprehensive, continuous feedback loop that ensures the ongoing refinement and highest level of instructional quality.

FIG. 5 is a flow diagram of method for generating diversified educational materials and documentation for training involves several steps. Initially, in step 502 SME training materials are stored in one or more task profiles within a memory of a processing server.

In step 504, the system then receives multi-modal input data, which includes dynamic user performance data and SME feedback. This data is collected via a communication interface from one or more user computing devices.

In step 506, utilizing a content generation module executed by the processing server, the system employs a generative AI model to produce a variety of educational outputs. These outputs include: a) static educational materials such as podcasts, test questions, and standard operating procedures (SOPs), b) interactive media and interactive question modules, c) education workflows and process documents.

In step 508, there is a dedicated SME review module provided, which enables an SME to review and modify the generated educational outputs and workflows as necessary.

Finally, instep 510, the educational outputs and workflows are updated based on the SME's review. The updated outputs are stored in the processing server's database and transmitted back to the user computing devices via a user interface.

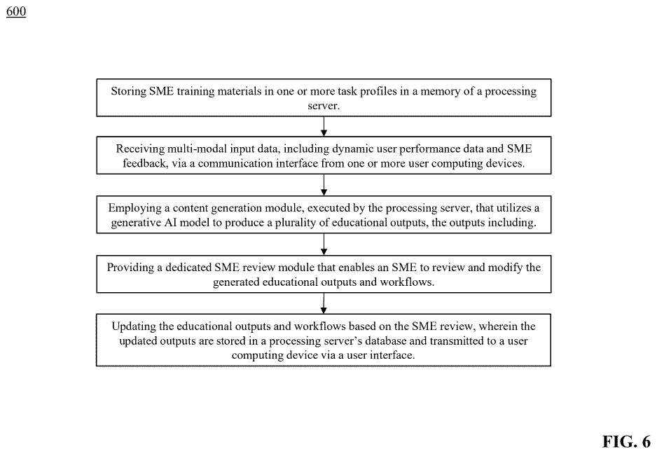

FIG. 6 is a flow diagram of a method begins by receiving multi-modal performance data from a user computing device through a communication interface. This performance data includes video data that captures the movement of surgical instruments, audio data, and sensor signals, in step 602.

Next, in step 604, the multi-modal performance data is ingested into a processing server that is equipped with a multi-modal data module designed to handle various types of data inputs.

The ingested performance data is then evaluated using an agentic framework. This evaluation aims to identify deviations from predefined performance benchmarks and assess the user's proficiency in the simulated tasks, as shown in step 606.

In step 608, based on the evaluation of the performance data, adaptive simulation parameters are generated. These parameters include real-time instructional overlays, adjustments to the difficulty of the scenario, and corrective feedback measures to aid the user's learning.

Finally, in step 610, the adaptive simulation parameters are transmitted to a simulation engine. This engine is configured to render an interactive, dynamic simulation training environment. The environment incorporates these adaptive parameters to provide real-time, context-aware guidance to the user.

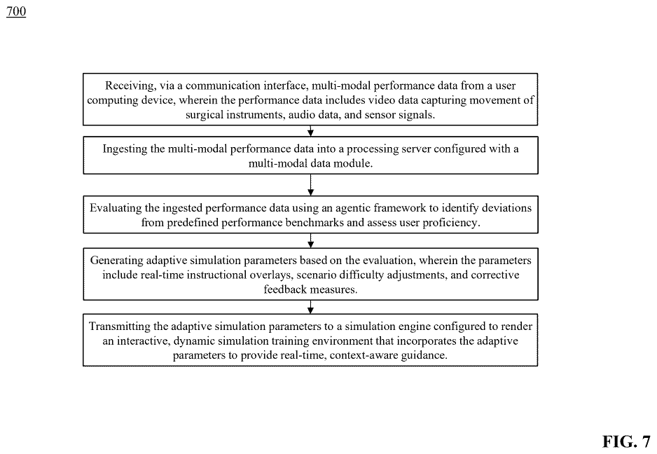

FIG. 7 is a flow diagram of a method for gamifying user training performance utilizing blockchain technology begins by capturing multi-modal user performance data during training simulations. This initial step 702 is crucial as it gathers the necessary data to inform the subsequent gamification process.

Following data capture, gamification metrics are generated based on the captured performance data in step 704. These metrics include reward points, badges, and other performance incentives that aim to enhance user engagement and motivation.

In step 706, the performance data and gamification metrics are then recorded in an immutable blockchain ledger, which is maintained by a processing server. This blockchain ledger serves as a secure and tamper-proof repository, ensuring the integrity of the data.

In step 708, in interactive leaderboard is generated next, ranking users based on the recorded performance metrics. This leaderboard fosters a competitive environment among users, encouraging them to improve their performance.

Finally, in step 710, the interactive leaderboard and associated gamification data are transmitted to user computing devices for display. The blockchain ledger underpinning this process provides tamper-proof validation of the performance data and gamification transactions, ensuring accuracy and trustworthiness in the system.

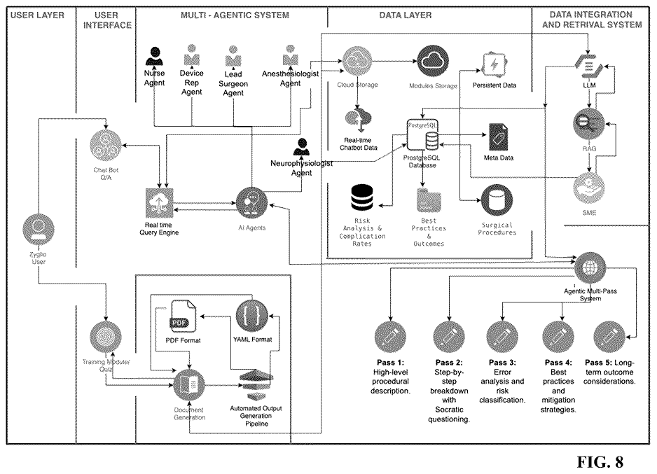

FIG. 8 diagram illustrates an intricate, multi-layered technological framework specifically tailored for healthcare settings, designed to enhance operational efficiency and patient care through advanced integration of user interfaces, multi-agent systems, and comprehensive data management. This advanced system designed to improve the documentation and analysis of surgical procedures through a highly sophisticated integration of AI-driven agents, structured data storage, and multi-format output capabilities. This system facilitates iterative collection, refinement, and validation of surgical data, ensuring evidence-based accuracy while also supporting interactive training and real-time question-and-answer sessions for medical professionals.

### Detailed Components of this Architecture

1. Agentic Multi-Pass Data Collection System (AutoGen Framework):
AI Agents with Expert Roles: The system includes multiple AI agents, each assigned to expert roles like Surgeon, Anesthesiologist, OR Nurse, Neurophysiologist, and Device Representative. Each agent is responsible for specific tasks:
   Surgeon Agent: Defines and outlines the procedural steps.
   Anesthesiologist Agent: Manages patient sedation and hemodynamics.
   Nurse Agent: Ensures sterility and availability of surgical instruments.
   Neurophysiologist Agent: Monitors and reports on neural functions during procedures.
   Device Rep Agent: Provides specifications and details for surgical implants.
Multi-Pass Inquiry Process: This process includes several passes for deepening the level of detail and accuracy:
   Pass 1: Provides a high-level overview of the procedure.
   Pass 2: Delivers a detailed, step-by-step breakdown through Socratic questioning.
   Pass 3: Conducts error analysis identifying risks at varying probabilities (e.g., 10%, 5%, 1%).
   Pass 4: Suggests best practices and risk mitigation strategies.
   Pass 5: Considers long-term outcomes and potential future implications.
2. Data Integration and Retrieval System:
LLM-Based Reasoning and Retrieval-augmented Generation (RAG):

Employs GPT-4 and AutoGen for initial content generation, complemented by RAG for fetching relevant medical guidelines and literature from databases like PubMed for evidence-based refinement.
Socratic Verification: Ensures data reliability and logical consistency through structured questioning.
Human Subject Matter Expert Review: Incorporates further validation by medical experts to refine and verify the AI-generated content.
3. Data Storage and Retrieval:
PostgreSQL Database: Manages structured data encompassing step-wise surgical workflows, error classifications, mitigation strategies, and pertinent literature references.
Vector Search (pgvector): Facilitates semantic searches across previous surgical cases, providing AI-driven recommendations and similar case analyses.
4. Output Generation and Interaction:
Data Representation: Generates structured outputs in JSON and YAML formats for seamless integration and usage across platforms.
PDF Documentation: Automatically compiles and formats detailed procedural documents using tools like PyYAML, ReportLab, WeasyPrint, and LaTeX.
Interactive Q&A Chatbot: Offers real-time assistance and learning opportunities for surgical teams through an interactive interface.
Training Module: Features adaptive questioning techniques to test and enhance the knowledge of medical professionals based on actual procedural data.

### System Integration and User Interface

The system architecture integrates these components through a user-friendly interface available on web and mobile apps, linking directly to both the interactive chatbot and the adaptive training module. This design supports a comprehensive approach to surgical data management, from initial data collection through to detailed procedural documentation and interactive learning tools.

Overall, this architecture represents a pioneering approach to surgical data management, leveraging the latest in artificial intelligence, data storage technologies, and interactive educational tools to significantly enhance the effectiveness and efficiency of medical teams in performing and learning from surgical procedures.

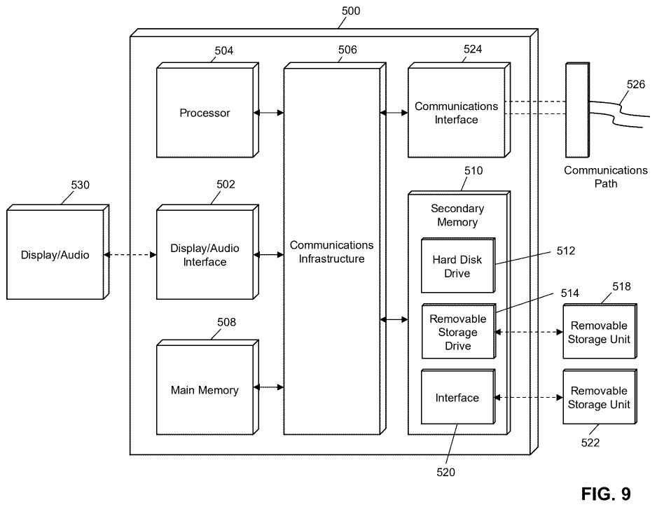

FIG. 9 illustrates a computer system 500 in which embodiments of the present disclosure, or portions thereof, may be implemented as computer-readable code executed on a variety of hardware platforms. The system architecture supports cloud-based processing, scalable data storage, vector and knowledge graph integration, and real-time multi-modal interaction required for adaptive training content generation. In addition, the architecture incorporates a specialized SME capture module that facilitates structured, multi-pass interviews with subject matter experts (SMEs). This module leverages advanced LLM agents equipped with detailed prompts to capture comprehensive workflows, decision points, and fallback strategies, which are then encoded into structured representations (e.g., in YAML format). The extracted decision trees are integrated into the agentic framework to inform both dynamic simulation scenarios and the generation of static educational materials. For instance, an LLM agent, integrated with PDF generation plug-ins such as WeasyPrint©, ReportLab©, or wkhtmltopdf©, automatically produces accurate Standard Operating Procedures (SOPs) and educational review documents that are auditable and reflect current industry standards. This comprehensive integration ensures that the system continuously refines its training content based on real-time performance feedback and evolving SME input, thereby enhancing instructional value and overall training effectiveness.

For example, the processing server 102, external data sources 104, and computing device 108 may be implemented using hardware, non-transitory computer-readable media storing instructions, or any combination thereof, across one or more computer systems or processing environments. The system 500 incorporates modular hardware components that implement the methods of FIGS. 3A, 3B, and 4, including advanced agentic frameworks that facilitate structured, multi-pass SME interviews, multi-turn voice interactions, and adaptive content generation. The computer system 500 supports high-fidelity, multi-modal content creation, encompassing audiovisual, audio-only, and three-dimensional simulation outputs, and real-time retrieval and annotation of multimedia instructional assets via integrated retrieval-augmented generation (RAG) modules. Security is ensured through robust measures, including zero-trust authentication protocols, encryption, role-based access control, and single sign-on (SSO) integration, facilitating secure corporate deployment and integration with enterprise systems such as Workday and Salesforce. Overall, the computer system 500 is a flexible, scalable architecture designed to support multi-agent interactions and real-time data processing, thereby enabling dynamic, personalized training and simulation environments.

In embodiments where programmable logic is utilized, such logic may be implemented on a commercially available processing platform configured by executable software code to function as a specific-purpose computer or a special-purpose device (e.g., a programmable logic array, an application-specific integrated circuit, etc.). It will be appreciated by those skilled in the art that the disclosed subject matter may be practiced on a wide variety of computer system configurations, including but not limited to multi-core multiprocessor systems, minicomputers, mainframe computers, distributed or clustered systems, as well as pervasive or miniature computing devices that can be embedded in virtually any apparatus. In one embodiment, at least one processor and an associated memory are employed to implement the described embodiments, including the multi-agent, agentic frameworks that facilitate real-time simulation, structured SME interviews, and adaptive content generation. This versatility in hardware configurations is critical for supporting the scalable, real-time processing requirements of the system and ensures that the invention may be effectively deployed in diverse environments ranging from high-performance cloud-based systems to on-premises or hybrid implementations.

In embodiments, a processor unit or device as disclosed herein may comprise a single processor, a plurality of processors, or any combination thereof, with each processor having one or more processing cores. The terms “computer program medium,” “non-transitory computer readable medium,” and “computer usable medium” are intended to encompass any tangible storage media, such as removable storage devices (e.g., units 518, 522), hard disk drives (e.g., unit 512), flash memory, optical discs, or other forms of non-volatile memory, on which the software components of the system are reliably stored in accordance with modern computing standards. This broad definition ensures that the invention may be implemented on a diverse range of computing platforms, including but not limited to embedded systems, cloud-based infrastructures, distributed architectures, and other configurations that meet the scalable, real-time processing requirements of the system.

Various embodiments of the present disclosure are described herein with reference to the example computer system 500, which exemplifies one embodiment of a versatile and scalable computing architecture. The system incorporates dynamic, adaptive features, including live simulation with responsive, multi-role agentic AI interactions (such as those achieved through structured SME interviews, multi-turn voice interactions, and decision-tree analysis), adaptive assessments, and multimedia instructional augmentation via retrieval-augmented generation (RAG) techniques, to substantially enhance user training outcomes. A person skilled in the art will recognize that the present disclosure can be implemented on alternative computer systems and architectures, whether cloud-based, on-premises, or deployed in a hybrid configuration, with operations performed sequentially, concurrently, or in a distributed manner. Moreover, program code may be stored locally or remotely for execution by single or multiple processor machines. In some embodiments, the order of operations may be rearranged without departing from the spirit or scope of the disclosed subject matter. This flexible operational paradigm ensures that the system can readily adapt to various hardware configurations and network environments while maintaining robust performance.

The processor device 504 can be a special purpose or a general-purpose processor device specifically configured to perform the functions discussed herein. The processor device 504 can be connected to a communications infrastructure 506, such as a bus, message queue, network, multi-core message-passing scheme, etc. The network can be any network suitable for performing the functions as disclosed herein and can include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 can also include a main memory 508 (e.g., random access memory, read-only memory, etc.), and can also include a secondary memory 510. The secondary memory 510 can include the hard disk drive 512 and a removable storage drive 514, such as a floppy disk drive, a magnetic tape drive, an optical disk drive, a flash memory, etc. These network and memory configurations support the robust data exchange and storage needs required for dynamic, real time simulations.

The removable storage drive 514 can read from and/or write to the removable storage unit 518 in a well-known manner. The removable storage unit 518 can include a removable storage media that can be read by and written to by the removable storage drive 514. For example, if the removable storage drive 514 is a floppy disk drive or universal serial bus port, the removable storage unit 518 can be a floppy disk or portable flash drive, respectively. In one embodiment, the removable storage unit 518 can be non-transitory computer readable recording media. This embodiment supports high speed data transfers and reliable media integrity.

In some embodiments, the secondary memory 510 can include alternative means for allowing computer programs or other instructions to be loaded into the computer system 500, for example, the removable storage unit 522 and an interface 520. Examples of such means can include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art. These alternative loading methods facilitate flexible software deployment.

Data stored in the computer system 500 (e.g., in the main memory 508 and/or the secondary memory 510) can be stored on any type of suitable computer readable media, such as optical storage (e.g., a compact disc, digital versatile disc, Blu-ray disc, etc.) or magnetic tape storage (e.g., a hard disk drive). The data can be configured in any type of suitable database configuration, such as a relational database, a structured query language (SQL) database, a distributed database, an object database, etc. Suitable configurations and storage types will be apparent to persons having skill in the relevant art. This flexibility in storage solutions ensures scalability and robustness in data management, as described.

The computer system 500 can also include a communications interface 524. The communications interface 524 can be configured to allow software and data to be transferred between the computer system 500 and external devices. Exemplary communications interfaces 524 can include a modem, a network interface (e.g., an Ethernet card), a communications port, a PCMCIA slot and card, etc. Software and data transferred via the communications interface 524 can be in the form of signals, which can be electronic, electromagnetic, optical, or other signals as will be apparent to persons having skill in the relevant art. The signals can travel via a communications path 526, which can be configured to carry the signals and can be implemented using wire, cable, fiber optics, a phone line, a cellular phone link, a radio frequency link, etc. This extensive communications capability ensures seamless connectivity and data exchange.

The computer system 500 can further include a display interface 502 configured to transfer data from the computer system 500 to an external display 530. Exemplary display/audio interfaces 502 may include high-definition multimedia interface (HDMI), digital visual interface (DVI), video graphics array (VGA), and similar standards. The external display 530 may be any suitable visual output device, such as a cathode ray tube (CRT) display, liquid crystal display (LCD), light-emitting diode (LED) display, capacitive touch display, thin-film transistor (TFT) display, and the like. In addition, display/audio interface 502 may incorporate an audio interface capable of outputting audio signals via a variety of digital, analog, and wireless standards which can generate audio (talk, alerts, sound ques, and nearly any other audio communication) via speakers or other sound generators. For example, digital audio outputs may be provided through USB audio, HDMI audio, or S/PDIF; analog audio outputs may be provided via RCA connectors or 3.5 mm jacks; and wireless audio outputs may utilize protocols such as Bluetooth, Wi-Fi, or Zigbee. These combined visual and/or audio output capabilities enable versatile multimodal communication with external devices, thereby enhancing user interaction and overall system flexibility.

Computer program medium and computer usable medium can refer to memories, such as the main memory 508 and secondary memory 510, which can be memory semiconductors (e.g., DRAMs, etc.). These computer program products can be means for providing software to the computer system 500. Computer programs (e.g., computer control logic) can be stored in the main memory 508 and/or the secondary memory 510.

Computer programs can also be received via the communications interface 524. Such computer programs, when executed, can enable computer system 500 to implement the present methods as discussed herein. In particular, the computer programs, when executed, can enable processor device 504 to implement the methods illustrated by FIGS. 3A, 3B, and 4, as discussed herein. Accordingly, such computer programs can represent controllers of the computer system 500. Where the present disclosure is implemented using software, the software can be stored in a computer program product and loaded into the computer system 500 using the removable storage drive 514, interface 520, and hard disk drive 512, or communications interface 524. This modular approach to software storage and execution underpins the system's flexibility and scalability.

The processor device 504 can comprise one or more modules or engines configured to perform the functions of the computer system 500. Each of the modules or engines can be implemented using hardware and, in some instances, can also utilize software, such as corresponding to program code and/or programs stored in the main memory 508 or secondary memory 510. In such instances, program code can be compiled by the processor device 504 (e.g., by a compiling module or engine) prior to execution by the hardware of the computer system 500. For example, the program code can be source code written in a programming language that is translated into a lower-level language, such as assembly language or machine code, for execution by the processor device 504 and/or any additional hardware components of the computer system 500. The process of compiling can include the use of lexical analysis, preprocessing, parsing, semantic analysis, syntax-directed translation, code generation, code optimization, and any other techniques that can be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above. This comprehensive compilation and execution process ensures optimal system performance.

In some embodiments, the method further includes compiling the generated training materials into adaptive briefings that integrate multiple instructional multimedia formats, such as text, video, audio, and interactive simulations. These adaptive briefings are dynamically updated in real time based on comprehensive user feedback, performance metrics, and sensor data. Leveraging a multi-agent framework informed by structured SME interviews and retrieval-augmented generation (RAG) techniques, the system continuously refines and curates the curriculum, ensuring that the training content remains current, personalized, and optimally aligned with the learner's evolving needs.

Embodiments of the present disclosure relate generally to a method and system for generative AI-driven agile content creation and management, particularly tailored for personalized training and simulation environments. In one embodiment, the presently disclosed system and method can employ advanced techniques, including retrieval-augmented generation (RAG), agentic multi-agent workflows (such as Microsoft's AutoGen framework), and real-time multi-turn voice interactions, integrated with dynamic multimedia and simulation display layers to produce adaptive, personalized learning experiences. The system can employ a modular software architecture comprising relational databases for structured data storage and may utilize tools such as LangChain© for orchestrating multi-source data retrieval and integration, YAML-based configuration files for defining simulation scenarios, and modular code components for executing adaptive content generation, assessment, and iterative feedback loops. The disclosed system can generate a wide variety of media outputs, including podcasts, interactive multiple-choice assessments, manuals, and e-learning modules, from captured training materials, thereby enhancing instructional effectiveness and enabling continuous improvement based on real-time user performance data. This document provides a comprehensive description of the architecture, methods, and implementation details of the invention, which may be embodied in various forms without departing from the scope of the disclosure.

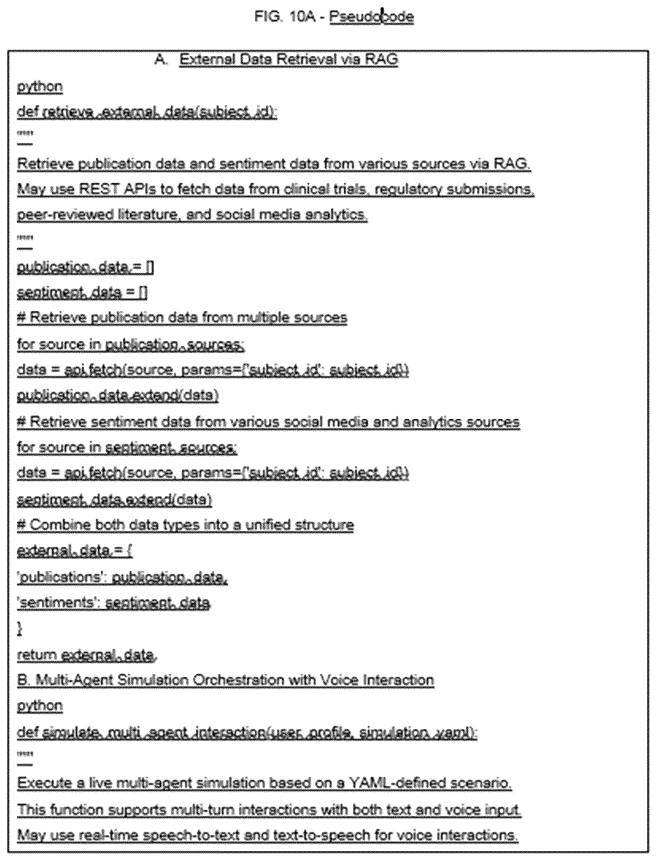

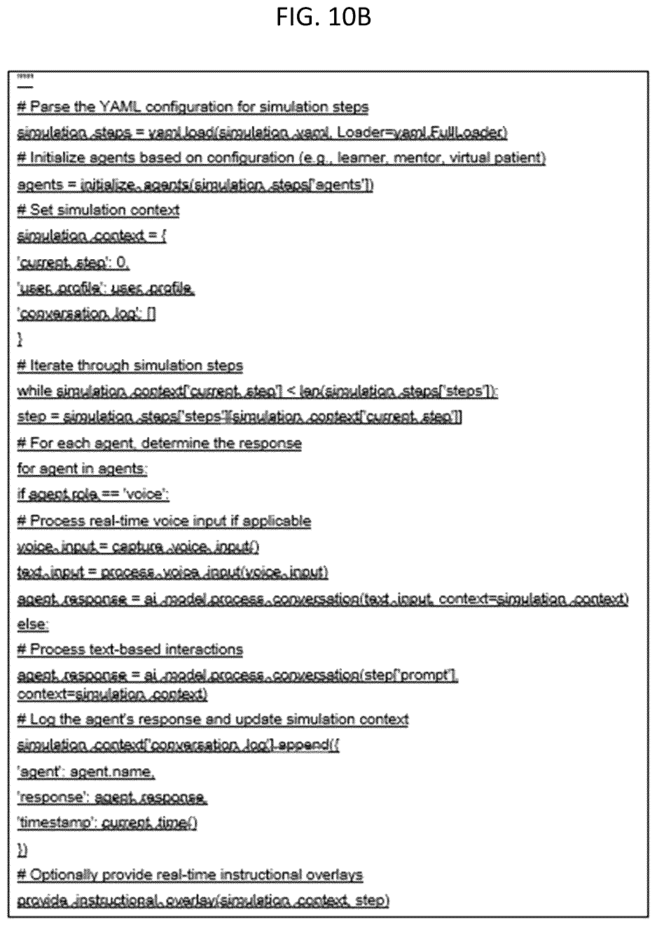

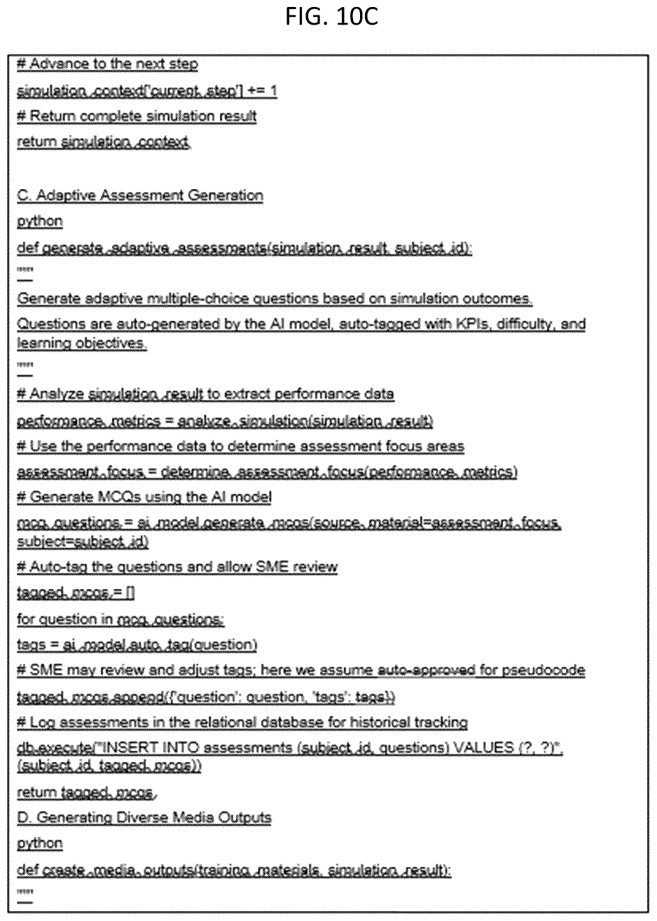

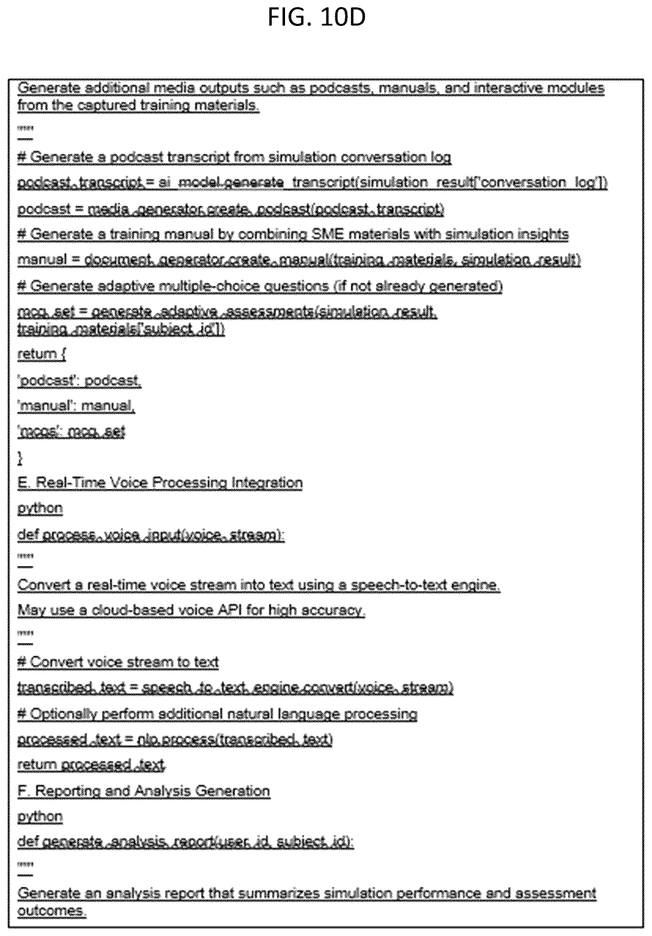

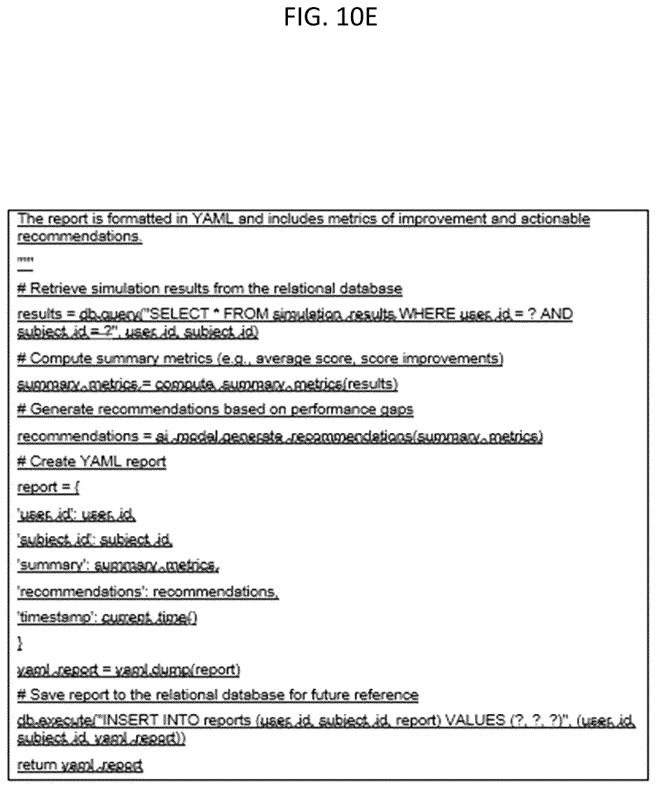

Provided in FIG. 10 is an extensive set of pseudocode blocks that collectively embody the concepts disclosed in this application. These pseudocode examples illustrate exemplary embodiments in which the system employs retrieval-augmented generation (RAG) within a multi-agent workflow, including frameworks such as Microsoft's AutoGen, to facilitate multi-turn voice interactions, dynamically generate adaptive assessments, and produce a variety of media outputs, including but not limited to podcasts, manuals, and interactive quizzes.

The foregoing detailed description and accompanying pseudocode examples are provided solely to illustrate one or more embodiments of the present invention and are not intended to limit its scope. It will be apparent to those skilled in the art that various modifications, substitutions, and enhancements can be made to the disclosed system, methods, and software architecture without departing from the spirit or scope of the appended claims. In one embodiment, the system may employ a LangGraph© structure in which nodes represent discrete steps in a process, and progression is contingent upon the simulation large language model (LLM) aggregating responses from multiple agentic personas, each embodying distinct subject matter expert (SME) perspectives, and advancing only when the learner's input meets predefined accuracy thresholds. This variant, wherein the LLM personas are maintained separately from the LangGraph, provides a flexible, conversational framework that supports real-time simulation run-throughs during SME capture sessions. The pseudocode examples herein serve to elucidate the implementation of the multi-agent workflow, real-time voice interactions, and adaptive content generation features of the system, and are not meant to restrict the invention to any specific programming language or environment. Accordingly, the invention is to be given the full scope of the appended claims and all equivalents thereto.

Techniques consistent with the present disclosure provide, among other features, systems and methods for creating and managing user-personalized training content using generative artificial intelligence (AI). In particular, the present disclosure discloses an agile content creation platform that integrates advanced techniques, such as retrieval-augmented generation (RAG), agentic multi-agent workflows (e.g., utilizing frameworks like Microsoft's AutoGen and LangGraph), real-time multi-turn voice interactions, and adaptive simulation modules, to dynamically generate and refine training materials based on SME inputs and user performance data. Various exemplary embodiments of the disclosed system and method have been described herein for illustrative purposes only and are not intended to limit the scope of the invention. Modifications, variations, and alternative implementations may be made in light of the teachings herein, including implementations on cloud-based, on-premises, or hybrid systems, and employing diverse multimedia outputs (such as audiovisual, audio-only, or three-dimensional interactive simulations) without departing from the spirit or scope of the invention as defined by the appended claims.

What is claimed is:

1. A system for generating user-personalized training content, comprising:
a processing server having a processor and a memory;
a storage module configured to store subject matter expert (SME) training materials in one or more task profiles, each task profile including a subject identifier uniquely designating a specific task, wherein the SME training materials comprise one or more of: a text document, a video, a diagram, an illustration, a textbook, an article, an audio file, a three-dimensional simulation, and audio input captured for integration into a large language model;
a user data module configured to store user performance data in one or more user profiles, each user profile comprising records of multi-modal inputs (e.g., audio, text, video) tagged with corresponding subject identifier;
a multi-agent orchestration module, executed by the processor, configured to conduct iterative, multi-pass interviews with SMEs using retrieval-augmented generation (RAG) and corrective RAG (CRAG) techniques to capture domain-specific knowledge and synthesize a structured knowledge base;
a content generation module, operatively coupled to the processor, configured to generate both static educational content and dynamic simulation training materials by integrating the structured knowledge base with real-time user performance data and adaptive instructional overlays;
a simulation engine configured to render dynamic, multi-agent procedural simulation scenarios based on the generated training materials; and
a communication interface for transmitting and receiving data between the processing server and one or more user computing devices.

2. The system of claim 1, wherein the multi-agent orchestration module comprises a plurality of specialized AI agents configured to engage in structured, multi-pass dialogues with SMEs, thereby capturing, indexing, and refining domain-specific knowledge, with the structured knowledge base continuously updated through automated feedback loops.

3. The system of claim 1, wherein the content generation module further integrates adaptive assessments and multimedia instructional overlays to enhance both static educational content and dynamic simulation training materials.

4. The system of claim 1, wherein the simulation engine supports multi-agent procedural simulations in which multiple AI agents, and optionally human mentors, interact in real time to adjust simulation scenarios, deliver adaptive guidance, and provide interactive feedback based on user inputs and contextual performance data.

5. The system of claim 1, further comprising an integration module configured to interface with enterprise learning management systems (LMS) and customer relationship management (CRM) systems via standardized APIs and robust authentication protocols, wherein real-time data fusion and dynamic resource allocation are employed to optimize training content generation and delivery.

6. The system of claim 1, further comprising a voice processing module configured to perform advanced speech-to-text and text-to-speech conversions using technologies such as Whisper, Sesame. ai, and ElevenLabs, thereby facilitating natural, real-time voice-based interactions within a multi-modal training environment.

7. The system of claim 1, wherein the user-personalized training content is configured for application in healthcare, further comprising a simulation engine adapted to generate live, interactive simulations of surgical and medical procedures, wherein the simulation engine integrates real-time multimedia instructional overlays, adaptive assessments, and performance analytics to tailor training content for healthcare practitioners.

8. The system of claim 1, wherein the user-personalized training content is configured for use in hospitality training environments, further comprising an interface module that delivers interactive, multi-agent simulations and real-time adaptive feedback to train personnel in customer service skills, front desk operations, and crisis management, and further integrating with enterprise CRM systems to optimize training outcomes.

9. The system of claim 1, wherein the user-personalized training content is configured for use in retail training environments, further comprising a simulation engine that generates dynamic, interactive scenarios for consultative selling, customer engagement, and product knowledge, wherein the system utilizes real-time performance data and adaptive assessments to tailor training to individual learning trajectories.

10. The system of claim 1, wherein the user-personalized training content is configured for use in financial services training, further comprising a simulation engine that produces interactive simulations for regulatory compliance, complex product education and client relationship management, wherein dynamic adaptive assessments and multi-modal instructional overlays are employed to enhance training effectiveness.

11. The system of claim 1, wherein the user-personalized training content is configured for use in manufacturing training environments, further comprising a simulation engine that generates interactive simulations for machine operation, quality control, and safety compliance, wherein the system dynamically adjusts training scenarios based on real-time feedback and integrates data from industrial control systems.

12. The system of claim 1, wherein the user-personalized training content is configured for use in high-stakes operational environments including manufacturing, aircraft operation, spacecraft operation, emergency response training, crisis management, structural engineering, civil engineering, and project management, further comprising a simulation engine configured to generate interactive simulations tailored to each respective industry, wherein the simulation engine dynamically adjusts training scenarios based on real-time performance feedback and integrates data from industry-specific control systems, such as industrial automation systems, flight control systems, emergency response monitoring systems, structural sensor networks, and project management platforms, thereby delivering context-aware, adaptive training experiences.

13. The system of claim 1, further comprising: a case parameterization module, wherein the processing server is configured to generate simulation cases by:
(a) automatically generating a decision tree representing possible simulation scenarios and outcomes using a large language model (LLM) based on a predefined knowledge base and adaptive learning algorithms;
(b) receiving descriptive inputs and parameters from one or more SMEs to specify simulation case details;
(c) employing a hybrid approach that combines an LLM-generated decision tree with the SME inputs to refine and enhance case details; and
(d) parameterizing simulation cases based on the LLM-generated decision tree, the SME input, or the hybrid input, thereby creating dynamic, interactive simulation scenarios that include branching decision points, outcome variations, and contextual instructional overlays.

14. The system of claim 1, wherein the user interface and content generation modules are configured to support a multi-tenant environment that accommodates diverse training needs across industries including healthcare, hospitality, retail, financial services, and manufacturing, thereby ensuring seamless interoperability with enterprise LMS and CRM systems and facilitating scalable, real-time training deployments.

15. The system of claim 1, further comprising:
a multi-agent LLM module configured to conduct iterative, multi-pass interviews with subject matter experts to capture domain-specific knowledge and contextual information, wherein captured SME information is synthesized into a structured knowledge base using RAG and CRAG techniques;
wherein the structured knowledge base is integrated into the content generation module to produce both static educational content and dynamic simulation training materials.

16. A system for generating personalized static educational content and dynamic simulation training materials, comprising:
a processing server having a processor and a memory;
a multi-agent large language model (LLM) module configured to conduct iterative, multi-pass interviews with SMEs to capture domain-specific knowledge and contextual information, and to synthesize such captured SME knowledge into a structured knowledge base;
a content generation module configured to generate both static educational content and dynamic simulation training materials by integrating the structured knowledge base with real-time user performance data and adaptive instructional overlays;
a storage module operatively coupled to the processing server for storing the structured knowledge base, the static educational content, and simulation parameters;
a simulation engine configured to render dynamic simulation scenarios based on the dynamically generated training materials; and
a communication interface for transmitting and receiving data between the processing server and one or more user computing devices,
wherein the multi-agent LLM module, the content generation module, and the simulation engine are implemented on dedicated hardware.

17. A system for delivering interactive, multi-modal simulation training, comprising:
a processing server having a processor and a memory, the processing server configured to execute a simulation engine that renders real-time interactive virtual reality (VR) and augmented reality (AR) environments using a game development platform;
a sensor module configured to capture multi-modal user interaction data from one or more user computing devices as the user interacts with the simulation environment;
an agentic LLM module operatively coupled to the processing server and the sensor module, configured to monitor the captured interaction data in real time, analyze user interactions with the simulation environment, and dynamically generate adaptive feedback and instructional overlays; and
a communication interface for transmitting the interactive simulation environment and dynamically generated adaptive feedback to the user computing devices,
wherein the system enables users to interact with the simulation environment via sensor inputs and receive real-time, context-aware feedback that optimizes their training experience.

18. A system for gamifying user training performance, comprising:
a processing server having a processor and a memory;
a blockchain module configured to securely record, validate, and store immutable records of user performance data and gamification metrics in a decentralized ledger;
a gamification module, operatively coupled to a processing server, configured to generate gamification elements including reward points, badges, and interactive leaderboards based on multi-modal user performance data captured during training simulations;
a communication interface for transmitting gamification data and leaderboard information to one or more user computing devices for display, wherein a displayed leaderboard ranks users based on performance metrics stored in the blockchain module;
wherein the blockchain module ensures transparency and tamper-proof tracking of all gamification transactions and performance records.

19. A method for generating user-personalized training content, comprising:
(a) storing subject matter expert (SME) training materials in one or more task profiles in a memory of a processing server, the task profiles including subject identifiers corresponding to specific tasks;
(b) storing user performance data in one or more user profiles in the processing server, each user profile comprising records of multi-modal inputs tagged with the respective subject identifiers;
(c) executing a multi-agent orchestration process on the processing server that conducts iterative, multi-pass interviews with SMEs using RAG and CRAG techniques to capture and structure domain-specific knowledge into a knowledge base;
(d) receiving, via a communication interface, a training request from a user computing device that includes a user identifier and a subject identifier;
(e) generating user-personalized training content by comparing the SME training materials with the user performance data and dynamically adapting the content based on real-time, multi-modal feedback from an agentic AI mentor;
(f) rendering dynamic simulation scenarios based on the generated training content using a simulation engine; and
(g) transmitting the generated training content and simulation outputs to the user computing device.

20. The method of claim 19, further comprising:
(a) administering pre-simulation, post-simulation, and spaced adaptive assessments to determine user proficiency and to generate feedback; and
(b) utilizing results of such assessments to continuously refine the structured knowledge base and adapt the generated training content accordingly.

21. The method of claim 19, further comprising dynamically integrating contextual instructional overlays, retrieved via RAG techniques, into a simulation environment, wherein the overlays provide real-time, adaptive guidance and corrective feedback that are continuously refined based on a trainee's interaction history and performance metrics.

22. The method of claim 19, further comprising selecting agentic SME personas, trained via multi-pass SME capture techniques using RAG methods, as approved virtual mentors, wherein these personas provide context-aware guidance and interactive feedback during the training process.

23. The method of claim 19, further comprising integrating with academic institutions and corporate training platforms to create a marketplace for AI education, wherein organizations may purchase or subscribe to customized training modules and curricula tailored to industry-specific requirements, including adaptive content for workforce upskilling.

24. The method of claim 19, further comprising:
(a) storing in the processing server a plurality of mentor profiles, each including a trained generative AI persona associated with a task profile;
(b) identifying one or more mentor profiles associated with the identified task profile when generating user-personalized training content; and
(c) generating and integrating AI mentor personas into user-personalized training content, wherein the generated training content is rendered as a video that includes interactive AI mentor personas that provide context-aware guidance during dynamic simulation training scenarios.

25. A method for generating diversified educational materials and documentation for training, comprising:
(a) storing SME training materials in one or more task profiles in a memory of a processing server;
(b) receiving multi-modal input data, including dynamic user performance data and SME feedback, via a communication interface from one or more user computing devices;
(c) employing a content generation module, executed by the processing server, that utilizes a generative AI model to produce a plurality of educational outputs, the outputs including:
(i) static educational materials selected from the group comprising podcasts, test questions, and standard operating procedures (SOPs);
(ii) interactive media and interactive question modules; and
(iii) education workflows and process documents;
(d) providing a dedicated SME review module that enables an SME to review and modify the generated educational outputs and workflows; and
(e) updating the educational outputs and workflows based on the SME review, wherein the updated outputs are stored in a processing server's database and transmitted to a user computing device via a user interface.

26. A method for dynamically adapting a simulation training environment based on multi-modal ingestion of user performance data, comprising:
(a) receiving, via a communication interface, multi-modal performance data from a user computing device, wherein the performance data includes video data capturing movement of surgical instruments, audio data, and sensor signals;
(b) ingesting the multi-modal performance data into a processing server configured with a multi-modal data module;
(c) evaluating the ingested performance data using an agentic framework to identify deviations from predefined performance benchmarks and assess user proficiency;
(d) generating adaptive simulation parameters based on the evaluation, wherein the parameters include real-time instructional overlays, scenario difficulty adjustments, and corrective feedback measures; and
(e) transmitting the adaptive simulation parameters to a simulation engine configured to render an interactive, dynamic simulation training environment that incorporates the adaptive parameters to provide real-time, context-aware guidance.

27. A method for gamifying user training performance using blockchain technology, comprising:
(a) capturing multi-modal user performance data during training simulations;
(b) generating gamification metrics, including reward points, badges, and other performance incentives, based on the captured performance data;
(c) recording the generated performance data and gamification metrics in an immutable blockchain ledger maintained by a processing server;
(d) generating an interactive leaderboard that ranks users based on the recorded performance metrics; and
(e) transmitting the interactive leaderboard and associated gamification data to user computing devices for display, wherein the blockchain ledger provides tamper-proof validation of the performance data and gamification transactions.
